(19) United States
(12) Patent Application Publication
(10) Pub. No.: US 2025/0389925 A1
(43) Pub. Date: Dec. 25, 2025

(54) IMAGE LENS ELEMENT, IMAGING LENS ASSEMBLY AND ELECTRONIC DEVICE

(71) Applicant: LARGAN PRECISION CO., LTD., Taichung City (TW)

(72) Inventors: Chun-Jui PAN, Taichung City (TW); Lin-An CHANG, Taichung City (TW); Chih-Wen HSU, Taichung City (TW)

(21) Appl. No.: 19/243,071

(22) Filed: Jun. 19, 2025

Related U.S. Application Data
(60) Provisional application No. 63/663,757, filed on Jun. 25, 2024.

(51) Int. Cl. G02B 7/02

(52) U.S. Cl. CPC G02B 7/021

(57) ABSTRACT

An image lens element has a central axis, and includes a first side surface, a second side surface and an outer diameter surface. The second side surface is disposed relatively to the first side surface along the central axis. The outer diameter surface is disposed between the first side surface and the second side surface. The outer diameter surface is farther to the central axis than each of the first side surface and the second side surface to the central axis, and includes an arc region and a shrinking region. The arc region includes a first stripe structure portion. The shrinking region extends along a direction around the central axis and is corresponded to two arc ends of the arc region. The shrinking region is closer to the central axis than the arc region to the central axis, and includes a second stripe structure portion.

### RELATED APPLICATIONS

This application claims priority to Provisional Application Ser. No. 63/663,757, filed Jun. 25, 2024, which is herein incorporated by reference.

### BACKGROUND

### Technical Field

The present disclosure relates to an image lens element and an imaging lens assembly. More particularly, the present disclosure relates to an image lens element and an imaging lens assembly applicable to portable electronic devices.

### Description of Related Art

In recent years, portable electronic devices have developed rapidly. For example, intelligent electronic devices and tablets have been filled in the lives of modern people, and imaging lens assemblies mounted on portable electronic devices have also prospered. However, as technology advances, the quality requirements of the imaging lens assembly are becoming higher and higher. Therefore, an imaging lens assembly, which can enhance the image quality, needs to be developed.

### SUMMARY

According to one aspect of the present disclosure, an image lens element, which has a central axis, and includes a first side surface, a second side surface and an outer diameter surface. The central axis passes through the first side surface, the first side surface includes, in order from a direction farther from the central axis, a first optical region and a first peripheral region. The central axis passes through a center of the first optical region. The first peripheral region is adjacent to and connected to the first optical region. The second side surface is disposed relatively to the first side surface along the central axis. The second side surface includes, in order from the direction farther from the central axis, a second optical region and a second peripheral region. The central axis passes through a center of the second optical region. The second peripheral region is adjacent to and connected to the second optical region. The outer diameter surface is disposed between the first side surface and the second side surface. The outer diameter surface is farther to the central axis than each of the first side surface and the second side surface to the central axis. The outer diameter surface includes an arc region and a shrinking region. The arc region is an arc-shaped centered on the central axis and having two arc ends. The arc region includes a first stripe structure portion, the first stripe structure portion has a plurality of first stripe structures, which extends from the first side surface to the second side surface, and the first stripe structures are arranged along the arc region around the central axis. The shrinking region extends along a direction around the central axis and having two end portions. The two end portions of the shrinking region are corresponded to the two arc ends of the arc region, and the shrinking region is closer to the central axis than the arc region to the central axis. The shrinking region includes a second stripe structure portion, the second stripe structure portion has a plurality of second stripe structures, which extends from the first side surface to the second side surface, and the second stripe structures are arranged from one of the two end portions to the other one of the two portions. An extending line of each of the first stripe structures meets on one point along a tapered surface, an extending line of each of the second stripe structures does not meet with each other on two extending directions of a plane.

According to one aspect of the present disclosure, an image lens element, which has a central axis, and includes a first side surface, a second side surface and an outer diameter surface. The central axis passes through the first side surface, the first side surface includes, in order from a direction farther from the central axis, a first optical region and a first peripheral region. The central axis passes through a center of the first optical region. The first peripheral region is adjacent to and connected to the first optical region. The second side surface is disposed relatively to the first side surface along the central axis. The second side surface includes, in order from the direction farther from the central axis, a second optical region and a second peripheral region. The central axis passes through a center of the second optical region. The second peripheral region is adjacent to and connected to the second optical region. The outer diameter surface is disposed between the first side surface and the second side surface. The outer diameter surface is farther to the central axis than each of the first side surface and the second side surface to the central axis. The outer diameter surface includes an arc region and a shrinking region. The arc region is an arc-shaped centered on the central axis and having two arc ends. The arc region includes a first stripe structure portion, the first stripe structure portion has a plurality of first stripe structures, which extends from the first side surface to the second side surface, and the first stripe structures are arranged along the arc region around the central axis. The shrinking region extends along a direction around the central axis and having two end portions. The two end portions of the shrinking region are corresponded to the two arc ends of the arc region, and the shrinking region is closer to the central axis than the arc region to the central axis. The shrinking region includes a second stripe structure portion, the second stripe structure portion has a plurality of second stripe structures, which extends from the first side surface to the second side surface, and the second stripe structures are arranged from one of the two end portions to the other one of the two portions. The outer diameter surface further includes a gate trace disposed on the shrinking region, wherein the gate trace is disposed adjacent to the second stripe structure portion along a direction of the central axis.

According to one aspect of the present disclosure, an image lens element, which has a central axis, and includes a first side surface, a second side surface and an outer diameter surface. The central axis passes through the first side surface, the first side surface includes, in order from a direction farther from the central axis, a first optical region and a first peripheral region. The central axis passes through a center of the first optical region. The first peripheral region is adjacent to and connected to the first optical region. The second side surface is disposed relatively to the first side surface along the central axis. The second side surface includes, in order from the direction farther from the central axis, a second optical region and a second peripheral region. The central axis passes through a center of the second optical region. The second peripheral region is adjacent to and connected to the second optical region. The outer diameter surface is disposed between the first side surface and the second side surface. The outer diameter surface is farther to the central axis than each of the first side surface and the second side surface to the central axis. The outer diameter surface includes an arc region and a shrinking region. The arc region is an arc-shaped centered on the central axis and having two arc ends. The arc region includes a first stripe structure portion, the first stripe structure portion has a plurality of first stripe structures, which extends from the first side surface to the second side surface, and the first stripe structures are arranged along the arc region around the central axis. The shrinking region extends along a direction around the central axis and having two end portions. The two end portions of the shrinking region are corresponded to the two arc ends of the arc region, and the shrinking region is closer to the central axis than the arc region to the central axis. The shrinking region includes a second stripe structure portion, the second stripe structure portion has a plurality of second stripe structures, which extends from the first side surface to the second side surface, and the second stripe structures are arranged from one of the two end portions to the other one of the two portions. The outer diameter surface further includes a transition region disposed between the two arc ends and the two end portions, and connecting the shrinking region and the arc region. The transition region includes a third stripe structure portion, the third stripe structure portion has at least two third stripe structures, which extends from the first side surface to the second side surface, an extending line of each of the at least two third stripe structures meets with each other on a third location, an extending line of each of the first stripe structures meets with each other on a first location, and the third location and the first location are different.

According to one aspect of the present disclosure, an image lens element, which has a central axis, and includes a first side surface, a second side surface and an outer diameter surface. The central axis passes through the first side surface, the first side surface includes, in order from a direction farther from the central axis, a first optical region and a first peripheral region. The central axis passes through a center of the first optical region. The first peripheral region is adjacent to and connected to the first optical region. The second side surface is disposed relatively to the first side surface along the central axis. The second side surface includes, in order from the direction farther from the central axis, a second optical region and a second peripheral region. The central axis passes through a center of the second optical region. The second peripheral region is adjacent to and connected to the second optical region. The outer diameter surface is disposed between the first side surface and the second side surface. The outer diameter surface is farther to the central axis than each of the first side surface and the second side surface to the central axis. The outer diameter surface includes an arc region and a shrinking region. The arc region is an arc-shaped centered on the central axis and having two arc ends. The arc region includes a first stripe structure portion, the first stripe structure portion has a plurality of first stripe structures, which extends from the first side surface to the second side surface, and the first stripe structures are arranged along the arc region around the central axis. The shrinking region extends along a direction around the central axis and having two end portions. The two end portions of the shrinking region are corresponded to the two arc ends of the arc region, and the shrinking region is closer to the central axis than the arc region to the central axis. The shrinking region includes a second stripe structure portion, the second stripe structure portion has a plurality of second stripe structures, which extends from the first side surface to the second side surface, and the second stripe structures are arranged from one of the two end portions to the other one of the two portions. The outer diameter surface further includes a transition region disposed between the two arc ends and the two end portions, and connecting the shrinking region and the arc region. The transition region includes a third stripe structure portion, the third stripe structure portion has at least two third stripe structures, which extends from the first side surface to the second side surface. An extending line of each of the at least two third stripe structures meets with each other on one point.

According to one aspect of the present disclosure, an imaging lens assembly includes a plastic lens barrel and an imaging lens set. The imaging lens set is disposed in the plastic lens barrel, and includes at least one of the aforementioned image lens element.

According to one aspect of the present disclosure, an electronic device includes the aforementioned imaging lens assembly.

### BRIEF DESCRIPTION OF THE DRAWINGS

FIG. 1A is a schematic view of an imaging lens assembly according to the 1st Embodiment of the present disclosure.

FIG. 1B is a three-dimensional schematic view of the image lens element according to the 1st example of the 1st embodiment of FIG. 1A.

FIG. 1C is a plane view of the image lens element of FIG. 1B.

FIG. 1D is a side view of the image lens element of FIG. 1B.

FIG. 1E is a schematic view of extending lines of the first stripe structures of FIG. 1B.

FIG. 1F is a schematic view of extending lines of the second stripe structures of FIG. 1B.

FIG. 1G is a schematic view of extending lines of the third stripe structures of FIG. 1B.

FIG. 1H is a schematic view of parameters of the image lens element of FIG. 1B.

FIG. 1I is another schematic view of parameters of the image lens element of FIG. 1B.

FIG. 1J is a partial enlarged view of the image lens element according to the 2nd example of the 1st embodiment of FIG. 1A.

FIG. 1K is a partial enlarged view of the image lens element according to the 3rd example of the 1st embodiment of FIG. 1A.

FIG. 1L is a partial enlarged view of the image lens element according to the 4th example of the 1st embodiment of FIG. 1A.

FIG. 1M is a partial enlarged view of the image lens element according to the 5th example of the 1st embodiment of FIG. 1A.

FIG. 2A is a schematic view of an imaging lens assembly according to the 2nd Embodiment of the present disclosure.

FIG. 2B is a three-dimensional schematic view of the image lens element according to the 1st example of the 2nd embodiment of FIG. 2A.

FIG. 2C is a plane view of the image lens element of FIG. 2B.

FIG. 2D is a side view of the image lens element of FIG. 2B.

FIG. 2E is a schematic view of extending lines of the first stripe structures of FIG. 2B.

FIG. 2F is a schematic view of extending lines of the second stripe structures of FIG. 2B.

FIG. 2G is a schematic view of extending lines of the third stripe structures of FIG. 2B.

FIG. 2H is a schematic view of parameters of the image lens element of FIG. 2B.

FIG. 2I is another schematic view of parameters of the image lens element of FIG. 2B.

FIG. 3A is a schematic view of an imaging lens assembly according to the 3rd Embodiment of the present disclosure.

FIG. 3B is a three-dimensional schematic view of the image lens element according to the 1st example of the 3rd embodiment of FIG. 3A.

FIG. 3C is a plane view of the image lens element of FIG. 3B.

FIG. 3D is a side view of the image lens element of FIG. 3B.

FIG. 3E is a schematic view of parameters of the image lens element of FIG. 3B.

FIG. 3F is another schematic view of parameters of the image lens element of FIG. 3B.

FIG. 4A is a schematic view of an electronic device according to the 4th embodiment of the present disclosure.

FIG. 4B is another schematic view of the electronic device according to the 4th embodiment of FIG. 4A.

FIG. 4C is a schematic view of an image captured via the electronic device according to the 4th embodiment of FIG. 4A.

FIG. 4D is another schematic view of the image captured via the electronic device according to the 4th embodiment of FIG. 4A.

FIG. 4E is the other schematic view of the image captured via the electronic device according to the 4th embodiment of FIG. 4A.

FIG. 5 is a schematic view of an electronic device according to the 5th embodiment of the present disclosure.

FIG. 6A is a schematic view of a vehicle instrument according to the 6th embodiment of the present disclosure.

FIG. 6B is another schematic view of the vehicle instrument according to the 6th embodiment in FIG. 6A.

FIG. 6C is another schematic view of the vehicle instrument according to the 6th embodiment in FIG. 6A.

### DETAILED DESCRIPTION

The present disclosure provides an image lens element, which has a central axis, and includes a first side surface, a second side surface and an outer diameter surface. The central axis passes through the first side surface, the first side surface includes, in order from a direction farther from the central axis, a first optical region and a first peripheral region. The central axis passes through a center of the first optical region. The first peripheral region is adjacent to and connected to the first optical region. The second side surface is disposed relatively to the first side surface along the central axis. The second side surface includes, in order from the direction farther from the central axis, a second optical region and a second peripheral region. The central axis passes through a center of the second optical region. The second peripheral region is adjacent to and connected to the second optical region. The outer diameter surface is disposed between the first side surface and the second side surface. The outer diameter surface is farther to the central axis than each of the first side surface and the second side surface to the central axis. The outer diameter surface includes an arc region and a shrinking region. The arc region is an arc-shaped centered on the central axis and having two arc ends. The arc region includes a first stripe structure portion, the first stripe structure portion has a plurality of first stripe structures, which extends from the first side surface to the second side surface, and the first stripe structures are arranged along the arc region around the central axis. The shrinking region extends along a direction around the central axis and having two end portions. The two end portions of the shrinking region are corresponded to the two arc ends of the arc region, and the shrinking region is closer to the central axis than the arc region to the central axis. The shrinking region includes a second stripe structure portion, the second stripe structure portion has a plurality of second stripe structures, which extends from the first side surface to the second side surface, and the second stripe structures are arranged from one of the two end portions to the other one of the two portions. An extending line of each of the first stripe structures meets on one point along a tapered surface, an extending line of each of the second stripe structures does not meet with each other on two extending directions of a plane. Therefore, the image lens element with stripe structures on the outer diameter surface is provided. During the manufacturing, a non-axisymmetric processing is utilized, which is favorable for decreasing the probability of stray light from the outer diameter surface. The arrangement of the first stripe structure portion and the second stripe structure portion can provide the manufacturability of the mold, and also provide the structural matching by different extending arrangements.

Specifically, the image lens element can be made of plastic transparent material. The arc region can form an incomplete circle, or be composed by several arcs. The two end portions of the shrinking region can be disposed adjacent to the arc region for forming a descend surface. Each of the first stripe structures and each of the second stripe structures can be different shapes, and the arrangement of the first stripe structures and the second stripe structures can be also different, so that the geometry structural matching can be achieved. The end of each of the first stripe structures and the end of each of the second stripe structures can be pointed angle, but can also be rounded angle depend on the different manufacturing conditions, and will not be limited thereto. The extending lines of the first stripe structures can meet on one point of the central axis or on one point deviating from the central axis. The extending lines of the second stripe structures do not meet with each other along a plane.

Each of the first stripe structures and each of the second stripe structures have a wedge-shaped tapered structure, and the wedge-shaped tapered structure tapers towards the direction farther from the central axis. Therefore, it is favorable for precisely controlling the structural completeness of each stripe structure of the image lens element.

The outer diameter surface can further include a gate trace disposed on the shrinking region, wherein the gate trace is disposed adjacent to the second stripe structure portion along a direction of the central axis. Therefore, it is favorable for maintaining the better molding efficiency and providing the appearance stability of the stripe structures.

When a first angle is formed between the first stripe structure portion and the central axis, and the first angle is θ1, the following condition is satisfied: 0 degrees≤θ1≤45 degrees. Therefore, the risk of the first stripe structures being damaged during assembling can be reduced. Further, the following condition can be satisfied: 0 degrees≤θ1≤25 degrees. Therefore, it is favorable for the sufficient extension of the lengths of the first stripe structures along the central axis and providing the releasing angle for the outer diameter surface.

When a second angle is formed between the second stripe structure portion and the central axis, and the second angle is θ2, the following condition is satisfied: 0 degrees≤θ2≤45 degrees. Therefore, the risk of the second stripe structures being damaged during assembling can be reduced. Further, the following condition can be satisfied: 0 degrees≤θ2≤25 degrees. Therefore, it is favorable for the sufficient extension of the lengths of the second stripe structures along the central axis and providing the releasing angle for the outer diameter surface.

When a length of the second stripe structure portion along the central axis is L, and a length of the second stripe structure portion along the one of the two end portions to the other one of the two portions is W, the following condition is satisfied: 0.10<L/W<1.10. Therefore, the processing conditions with better efficiency can be provided. Further, the following condition can be satisfied: 0.15<L/W<0.85. Therefore, it is favorable for ensuring that the sufficient area of the shrinking region can be covered by the second stripe structure portion.

One of the first optical region and the second optical region can have a concave portion. Therefore, it is applicable to the image lens element with concave surface. Further, the concave portion is disposed relative to the first stripe structure portion and the second stripe structure portion along the direction farther from the central axis. Therefore, it is favorable for eliminating the stray light which is reflected inside the lens element.

When a distance along the central axis between a center to an edge of the one of the first optical region and the second optical region having the concave portion is S, and a distance between the center of the first optical region and the center of the second optical region is CT, the following condition is satisfied: 0.6<S/CT<2.7. Therefore, the image lens element with greater curvature can be provided, which can be widely applied to the imaging lens assembly with high optical quality. Therefore, the following condition can be satisfied: 0.7<S/CT<2.3. Therefore, the molding precision of the optical region can be further considered.

The present disclosure provides an image lens element, which has a central axis, and includes a first side surface, a second side surface and an outer diameter surface. The central axis passes through the first side surface, the first side surface includes, in order from a direction farther from the central axis, a first optical region and a first peripheral region. The central axis passes through a center of the first optical region. The first peripheral region is adjacent to and connected to the first optical region. The second side surface is disposed relatively to the first side surface along the central axis. The second side surface includes, in order from the direction farther from the central axis, a second optical region and a second peripheral region. The central axis passes through a center of the second optical region. The second peripheral region is adjacent to and connected to the second optical region. The outer diameter surface is disposed between the first side surface and the second side surface. The outer diameter surface is farther to the central axis than each of the first side surface and the second side surface to the central axis. The outer diameter surface includes an arc region and a shrinking region. The arc region is an arc-shaped centered on the central axis and having two arc ends. The arc region includes a first stripe structure portion, the first stripe structure portion has a plurality of first stripe structures, which extends from the first side surface to the second side surface, and the first stripe structures are arranged along the arc region around the central axis. The shrinking region extends along a direction around the central axis and having two end portions. The two end portions of the shrinking region are corresponded to the two arc ends of the arc region, and the shrinking region is closer to the central axis than the arc region to the central axis. The shrinking region includes a second stripe structure portion, the second stripe structure portion has a plurality of second stripe structures, which extends from the first side surface to the second side surface, and the second stripe structures are arranged from one of the two end portions to the other one of the two portions. The outer diameter surface further includes a gate trace disposed on the shrinking region, wherein the gate trace is disposed adjacent to the second stripe structure portion along a direction of the central axis. Therefore, the image lens element with stripe structures on the outer diameter surface is provided. During the manufacturing, a non-axisymmetric processing is utilized, which is favorable for decreasing the probability of stray light from the outer diameter surface. The arrangement of the first stripe structure portion and the second stripe structure portion can provide the manufacturability of the mold, and it is favorable for maintaining the better molding efficiency and providing the appearance stability of the stripe structures.

Each of the first stripe structures and each of the second stripe structures have a wedge-shaped tapered structure, and the wedge-shaped tapered structure tapers towards the direction farther from the central axis. Therefore, it is favorable for precisely controlling the structural completeness of each stripe structure of the image lens element.

When a second angle is formed between the second stripe structure portion and the central axis, and the second angle is θ2, the following condition is satisfied: 0 degrees≤θ2≤45 degrees. Therefore, the risk of the second stripe structures being damaged during assembling can be reduced. Further, the following condition can be satisfied: 0 degrees≤θ2≤25 degrees. Therefore, it is favorable for the sufficient extension of the lengths of the second stripe structures along the central axis and providing the releasing angle for the outer diameter surface.

When a length of the second stripe structure portion along the central axis is L, and a length of the second stripe structure portion along the one of the two end portions to the other one of the two portions is W, the following condition is satisfied: 0.10<L/W<1.10. Therefore, the processing conditions with better efficiency can be provided. Further, the following condition can be satisfied: 0.15<L/W<0.85. Therefore, it is favorable for ensuring that the sufficient area of the shrinking region can be covered by the second stripe structure portion.

One of the first optical region and the second optical region can have a concave portion. Therefore, it is applicable to the image lens element with concave surface. Further, the concave portion is disposed relative to the first stripe structure portion and the second stripe structure portion along the direction farther from the central axis. Therefore, it is favorable for eliminating the stray light which is reflected inside the lens element.

When a distance along the central axis between a center to an edge of the one of the first optical region and the second optical region having the concave portion is S, and a distance between the center of the first optical region and the center of the second optical region is CT, the following condition is satisfied: 0.6<S/CT<2.7. Therefore, the image lens element with greater curvature can be provided, which can be widely applied to the imaging lens assembly with high optical quality. Therefore, the following condition can be satisfied: 0.7<S/CT<2.3. Therefore, the molding precision of the optical region can be further considered.

The present disclosure provides an image lens element, which has a central axis, and includes a first side surface, a second side surface and an outer diameter surface. The central axis passes through the first side surface, the first side surface includes, in order from a direction farther from the central axis, a first optical region and a first peripheral region. The central axis passes through a center of the first optical region. The first peripheral region is adjacent to and connected to the first optical region. The second side surface is disposed relatively to the first side surface along the central axis. The second side surface includes, in order from the direction farther from the central axis, a second optical region and a second peripheral region. The central axis passes through a center of the second optical region. The second peripheral region is adjacent to and connected to the second optical region. The outer diameter surface is disposed between the first side surface and the second side surface. The outer diameter surface is farther to the central axis than each of the first side surface and the second side surface to the central axis. The outer diameter surface includes an arc region and a shrinking region. The arc region is an arc-shaped centered on the central axis and having two arc ends. The arc region includes a first stripe structure portion, the first stripe structure portion has a plurality of first stripe structures, which extends from the first side surface to the second side surface, and the first stripe structures are arranged along the arc region around the central axis. The shrinking region extends along a direction around the central axis and having two end portions. The two end portions of the shrinking region are corresponded to the two arc ends of the arc region, and the shrinking region is closer to the central axis than the arc region to the central axis. The shrinking region includes a second stripe structure portion, the second stripe structure portion has a plurality of second stripe structures, which extends from the first side surface to the second side surface, and the second stripe structures are arranged from one of the two end portions to the other one of the two portions. The outer diameter surface further includes a transition region disposed between the two arc ends and the two end portions, and connecting the shrinking region and the arc region. The transition region includes a third stripe structure portion, the third stripe structure portion has at least two third stripe structures, which extends from the first side surface to the second side surface, an extending line of each of the at least two third stripe structures meets with each other on a third location, an extending line of each of the first stripe structures meets with each other on a first location, and the third location and the first location are different. Therefore, the image lens element with stripe structures on the outer diameter surface is provided. During the manufacturing, a non-axisymmetric processing is utilized, which is favorable for decreasing the probability of stray light from the outer diameter surface. The arrangement of the first stripe structure portion and the second stripe structure portion can provide the manufacturability of the mold, and the third stripe structure portion of the transition region can provide buffering area for the manufacturing of mold so as to arrange the stripe structure closer.

Each of the first stripe structures and each of the second stripe structures have a wedge-shaped tapered structure, and the wedge-shaped tapered structure tapers towards the direction farther from the central axis. Therefore, it is favorable for precisely controlling the structural completeness of each stripe structure of the image lens element.

Each of the at least two third stripe structures has a wedge-shaped tapered structure, and the wedge-shaped tapered structure tapers towards the direction farther from the central axis. Therefore, it is favorable for precisely controlling the structural completeness of each stripe structure of the image lens element.

When a length of the second stripe structure portion along the central axis is L, and a length of the second stripe structure portion along the one of the two end portions to the other one of the two portions is W, the following condition is satisfied: 0.10<L/W<1.10. Therefore, the processing conditions with better efficiency can be provided. Further, the following condition can be satisfied: 0.15<L/W<0.85. Therefore, it is favorable for ensuring that the sufficient area of the shrinking region can be covered by the second stripe structure portion.

When a first angle is formed between the first stripe structure portion and the central axis, and the first angle is θ1, the following condition is satisfied: 0 degrees≤θ1≤45 degrees. Therefore, the risk of the first stripe structures being damaged during assembling can be reduced. Further, the following condition can be satisfied: 0 degrees≤θ1≤25 degrees. Therefore, it is favorable for the sufficient extension of the lengths of the first stripe structures along the central axis and providing the releasing angle for the outer diameter surface.

The present disclosure provides an image lens element, which has a central axis, and includes a first side surface, a second side surface and an outer diameter surface. The central axis passes through the first side surface, the first side surface includes, in order from a direction farther from the central axis, a first optical region and a first peripheral region. The central axis passes through a center of the first optical region. The first peripheral region is adjacent to and connected to the first optical region. The second side surface is disposed relatively to the first side surface along the central axis. The second side surface includes, in order from the direction farther from the central axis, a second optical region and a second peripheral region. The central axis passes through a center of the second optical region. The second peripheral region is adjacent to and connected to the second optical region. The outer diameter surface is disposed between the first side surface and the second side surface. The outer diameter surface is farther to the central axis than each of the first side surface and the second side surface to the central axis. The outer diameter surface includes an arc region and a shrinking region. The arc region is an arc-shaped centered on the central axis and having two arc ends. The arc region includes a first stripe structure portion, the first stripe structure portion has a plurality of first stripe structures, which extends from the first side surface to the second side surface, and the first stripe structures are arranged along the arc region around the central axis. The shrinking region extends along a direction around the central axis and having two end portions. The two end portions of the shrinking region are corresponded to the two arc ends of the arc region, and the shrinking region is closer to the central axis than the arc region to the central axis. The shrinking region includes a second stripe structure portion, the second stripe structure portion has a plurality of second stripe structures, which extends from the first side surface to the second side surface, and the second stripe structures are arranged from one of the two end portions to the other one of the two portions. The outer diameter surface further includes a transition region disposed between the two arc ends and the two end portions, and connecting the shrinking region and the arc region. The transition region includes a third stripe structure portion, the third stripe structure portion has at least two third stripe structures, which extends from the first side surface to the second side surface. An extending line of each of the at least two third stripe structures meets with each other on one point. Therefore, the image lens element with stripe structures on the outer diameter surface is provided. During the manufacturing, a non-axisymmetric processing is utilized, which is favorable for decreasing the probability of stray light from the outer diameter surface. The arrangement of the first stripe structure portion and the second stripe structure portion can provide the manufacturability of the mold. Further, the third stripe structure portion of the transition region can provide structural matching cooperating with the first stripe structure portion and the second stripe structure portion.

Each of the first stripe structures and each of the second stripe structures have a wedge-shaped tapered structure, and the wedge-shaped tapered structure tapers towards the direction farther from the central axis. Therefore, it is favorable for precisely controlling the structural completeness of each stripe structure of the image lens element.

Each of the at least two third stripe structures has a wedge-shaped tapered structure, and the wedge-shaped tapered structure tapers towards the direction farther from the central axis. Therefore, it is favorable for precisely controlling the structural completeness of each stripe structure of the image lens element.

When a first angle is formed between the first stripe structure portion and the central axis, and the first angle is θ1, the following condition is satisfied: 0 degrees≤θ1≤45 degrees. Therefore, the risk of the first stripe structures being damaged during assembling can be reduced. Further, the following condition can be satisfied: 0 degrees≤θ1≤25 degrees. Therefore, it is favorable for the sufficient extension of the lengths of the first stripe structures along the central axis and providing the releasing angle for the outer diameter surface.

When a second angle is formed between the second stripe structure portion and the central axis, and the second angle is θ2, the following condition is satisfied: 0 degrees≤θ2≤45 degrees. Therefore, the risk of the second stripe structures being damaged during assembling can be reduced. Further, the following condition can be satisfied: 0 degrees≤θ2≤25 degrees. Therefore, it is favorable for the sufficient extension of the lengths of the second stripe structures along the central axis and providing the releasing angle for the outer diameter surface.

The present disclosure provides an imaging lens assembly, which includes a plastic lens barrel and an imaging lens set. The imaging lens set is disposed in the plastic lens barrel, and includes at least one of the aforementioned image lens element.

The present disclosure provides an electronic device, which includes the aforementioned imaging lens assembly.

### 1st Embodiment

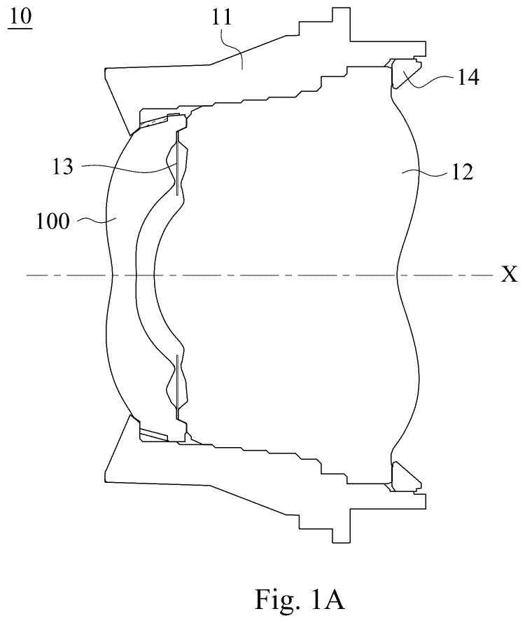

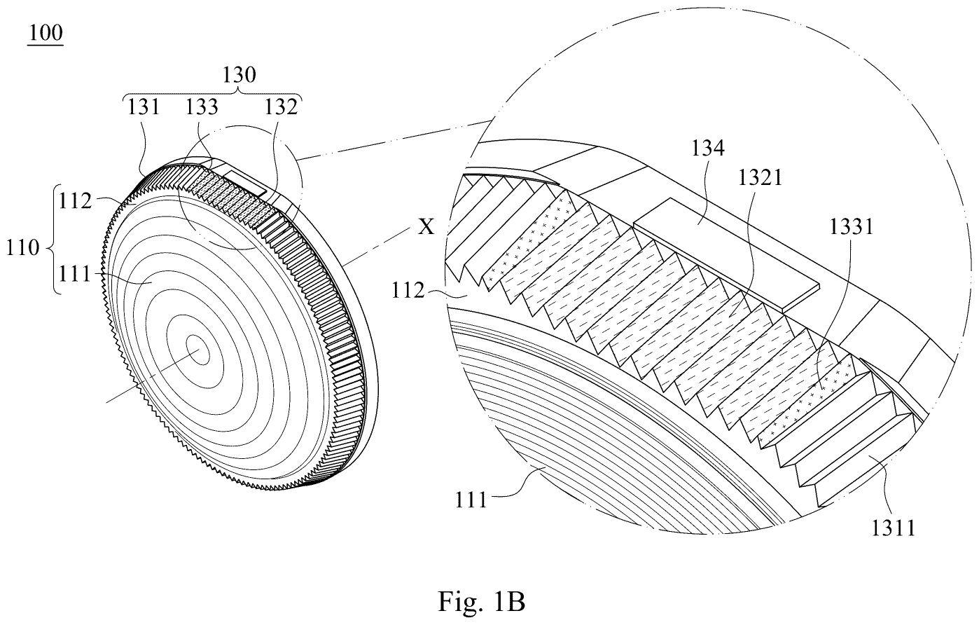

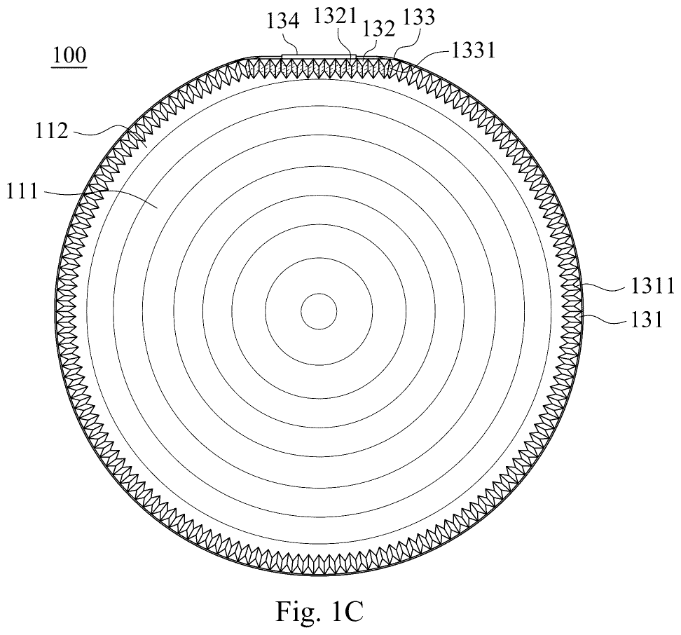

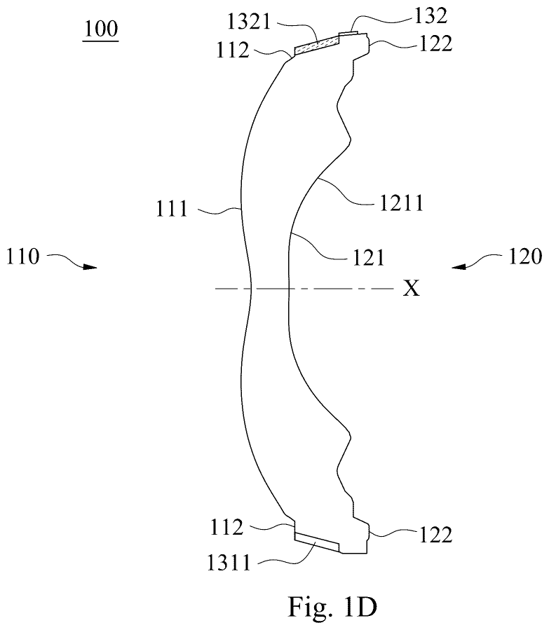

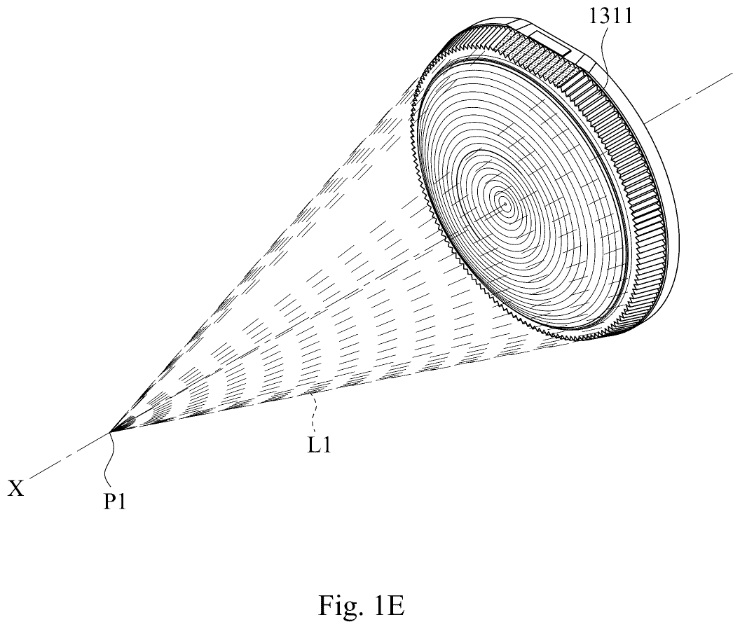

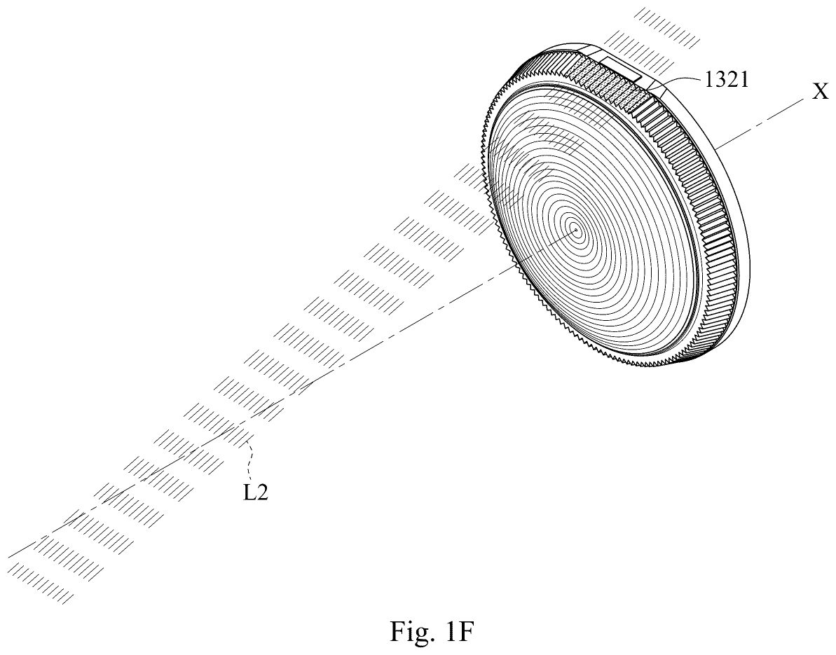

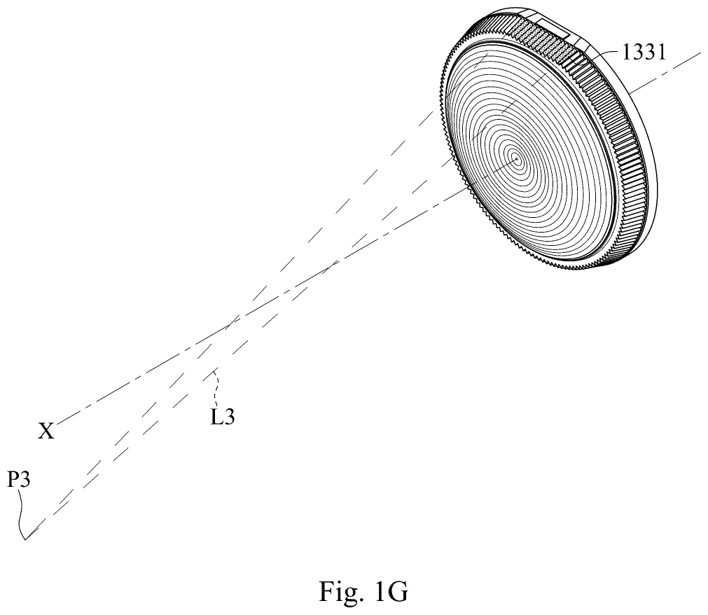

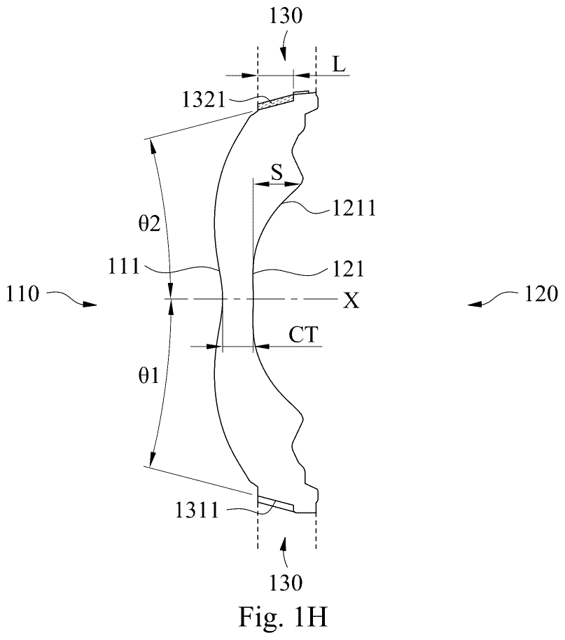

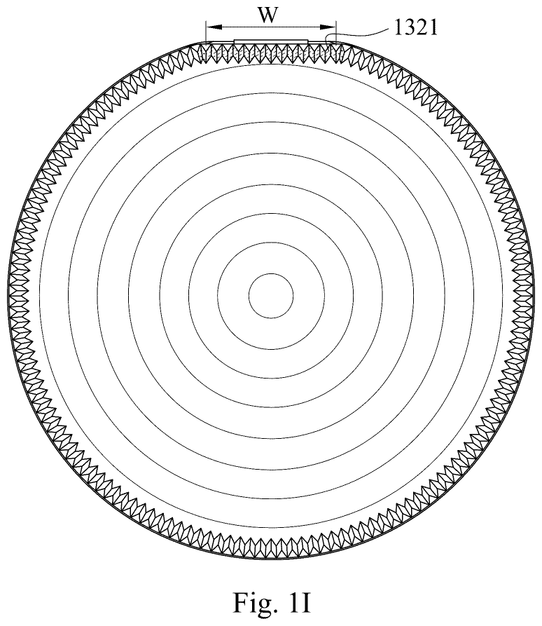

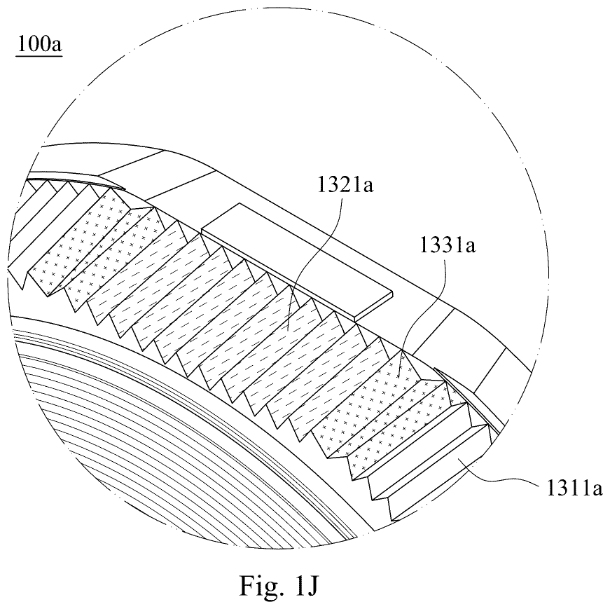

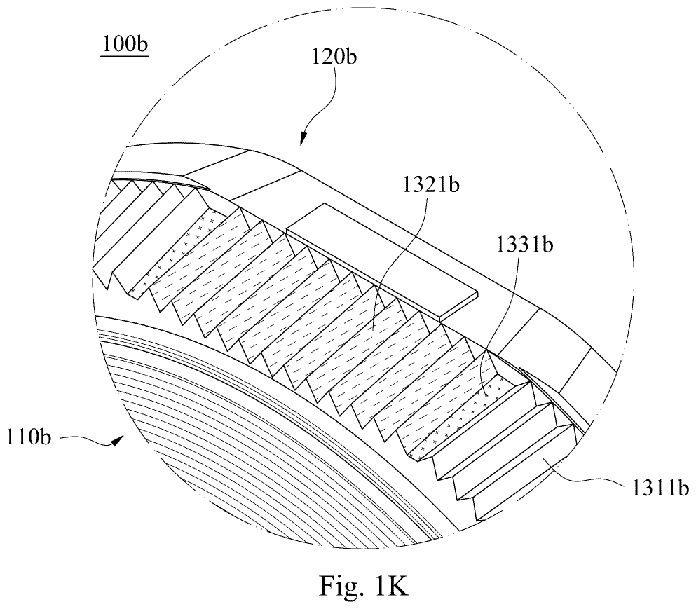

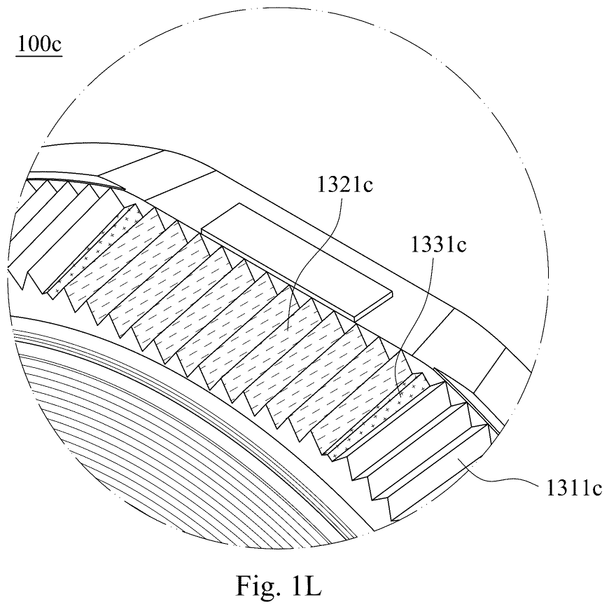

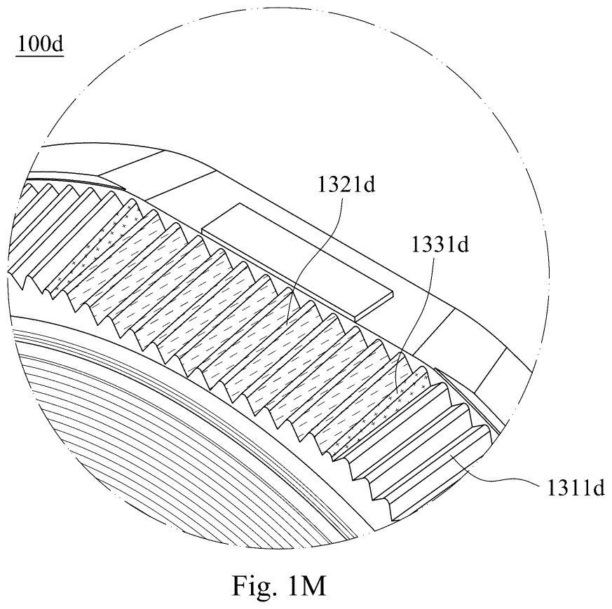

FIG. 1A is a schematic view of an imaging lens assembly 10 according to the 1st Embodiment of the present disclosure. In FIG. 1A, the imaging lens assembly 10 includes a plastic lens barrel 11 and an imaging lens set (its reference numeral is omitted), wherein the imaging lens set is disposed in the plastic lens barrel 11. The imaging lens set includes an image lens element 100 and at least one lens element 12, wherein the image lens element 100 is made of plastic transparent material, the lens element 12 can be the image lens element of the present disclosure or other lens element with refractive power on demand, and the present disclosure will not be limited thereto. Further, the imaging lens assembly 10 can further include a light blocking sheet 13 and a retainer 14, wherein the light blocking sheet 13 can connect the image lens element 100 and the adjacent lens element 12, the retainer 14 can be disposed on an image side of the most image side lens element 12, which is for positioning the lens element 12, however different amount or types of optical elements can be disposed on demand, the present disclosure will not be limited thereto.

FIG. 1B is a three-dimensional schematic view of the image lens element 100 according to the 1st example of the 1st embodiment of FIG. 1A, FIG. 1C is a plane view of the image lens element 100 of FIG. 1B, and FIG. 1D is a side view of the image lens element 100 of FIG. 1B. In FIG. 1B to FIG. 1D, the image lens element 100 includes a first side surface 110, a second side surface 120 and an outer diameter surface 130. The central axis X passes through the first side surface 110 and the second side surface 120. The second side surface 120 is disposed relatively to the first side surface 110 along the central axis X. The outer diameter surface 130 is disposed between the first side surface 110 and the second side surface 120, and the outer diameter surface 130 is farther to the central axis X than each of the first side surface 110 and the second side surface 120 to the central axis X.

The first side surface 110 includes, in order from a direction farther from the central axis X, a first optical region 111 and a first peripheral region 112. The central axis X passes through a center of the first optical region 111. The first peripheral region 112 is adjacent to and connected to the first optical region 111. The second side surface 120 includes, in order from the direction farther from the central axis X, a second optical region 121 and a second peripheral region 122. The central axis X passes through a center of the second optical region 121. The second peripheral region 122 is adjacent to and connected to the second optical region 121.

The outer diameter surface 130 includes an arc region 131, a shrinking region 132 and a transition region 133. The arc region 131 is an arc-shaped centered on the central axis X and has two arc ends. The shrinking region 132 extends along a direction around the central axis X and has two end portions. The two end portions of the shrinking region 132 are corresponded to the two arc ends of the arc region 131, and the shrinking region 132 is closer to the central axis than the arc region 131 to the central axis X. The transition region 133 is disposed between the two arc ends and the two end portions, and connects the shrinking region 132 and the arc region 131. Specifically, the two end portions of the shrinking region 132 and the arc ends of the arc region 131 are adjacent to each other and disposed via the transition region 133 so as to form a descend surface.

The arc region 131 includes a first stripe structure portion 1311, the first stripe structure portion 1311 has a plurality of first stripe structures (its reference numeral is omitted), which extends from the first side surface 110 to the second side surface 120, and the first stripe structures are arranged along the arc region around the central axis X. The shrinking region 132 includes a second stripe structure portion 1321, the second stripe structure portion 1321 has a plurality of second stripe structures, which extends from the first side surface 110 to the second side surface 120, and the second stripe structures are arranged from one of the two end portions to the other one of the two portions. The transition region 133 includes a third stripe structure portion 1331, the third stripe structure portion 1331 has two third stripe structures, which extends from the first side surface 110 to the second side surface 120. In FIG. 1B, each of the first stripe structures, each of the second stripe structures and each of the third stripe structures have a wedge-shaped tapered structure, and the wedge-shaped tapered structure tapers towards the direction farther from the central axis X. Further, the end of each of the first stripe structures, the end of each of the second stripe structures and the end of each of the third stripe structures are pointed angle.

FIG. 1E is a schematic view of extending lines L1 of the first stripe structures of FIG. 1B, FIG. 1F is a schematic view of extending lines L2 of the second stripe structures of FIG. 1B, and FIG. 1G is a schematic view of extending lines L3 of the third stripe structures of FIG. 1B. As shown in FIG. 1E, in the first stripe structure portion 1311, the extending lines L1 of the first stripe structures meet on one point P1 along a tapered surface, wherein, according to the 1st example of the 1st embodiment, the point P1 is on the central axis X, but the present disclosure will not be limited thereto. As shown in FIG. 1F, in the second stripe structure portion 1321, the extending lines L2 of the second stripe structures do not meet with each other on two extending directions of a plane, but the present disclosure will not be limited thereto. As shown in FIG. 1G, in the third stripe structure portion 1331, the extending lines L3 of the third stripe structures meet with each other on one point P3, wherein, according to the 1st example of the 1st embodiment, the point P3 deviates the central axis X. Moreover, as shown in both of FIG. 1E and FIG. 1G, the extending lines L3 of the third stripe structures meet with each other on a third location (that is, the point P3), the extending lines L1 of the first stripe structures meet with each other on a first location (that is, the point P1), and the third location (that is, the point P3) and the first location (that is, the point P1) are different.

In FIG. 1D, the second optical region 121 has a concave portion 1211, wherein the concave portion 1211 is disposed relative to the first stripe structure portion 1311 and the second stripe structure portion 1321 along the direction farther from the central axis X.

In FIG. 1B and FIG. 1C, the outer diameter surface 130 can further include a gate trace 134 disposed on the shrinking region 132, wherein the gate trace 134 is disposed adjacent to the second stripe structure portion 1321 along a direction of the central axis X.

FIG. 1H and FIG. 1I are schematic views of parameters of the image lens element 100 of FIG. 1B, respectively. In FIG. 1H and FIG. 1I, according to the 1st example of the 1st embodiment, when a first angle is formed between the first stripe structure portion 1311 and the central axis X, the first angle is θ1, a second angle is formed between the second stripe structure portion 1321 and the central axis X, the second angle is θ2, a length of the second stripe structure portion 1321 along the central axis X is L, a length of the second stripe structure portion 1321 along the one of the two end portions to the other one of the two portions is W, a distance along the central axis X between a center to an edge of the one of the first optical region 111 and the second optical region 121 having the concave portion 1211 (according to the 1st example of the 1st embodiment, that is the second optical region 121) is S, and a distance between the center of the first optical region 111 and the center of the second optical region 121 is CT, the data in the following Table 1A are satisfied.

TABLE 1A
1st example of the 1st embodiment

| θ1 | (degrees) | 15 | L/W | | 0.338 |
|---|---|---|---|---|---|
| θ2 | (degrees) | 15 | S | (mm) | 0.632 |
| L | (mm) | 0.475 | CT | (mm) | 0.408 |

| | | | | |
|---|---|---|---|---|
| W | (mm) | 1.407 | S/CT | 1.549 |

FIG. 1J is a partial enlarged view of the image lens element 100a according to the 2nd example of the 1st embodiment of FIG. 1A. In FIG. 1J, the difference between the image lens element 100a of the 2nd example and the image lens element 100 of the 1st example is that, the third stripe structure portion 1331a has four third stripe structures (its reference numeral is omitted) in the image lens element 100a of the 2nd example. Each two third stripe structures are disposed between the first stripe structure portion 1311a and the second stripe structure portion 1321a.

Other structural characteristics, parameters and arrangements of the image lens element 100a of the 2nd example can be the same or similar to the image lens element 100 of the 1st example, and will not be mentioned again herein.

FIG. 1K is a partial enlarged view of the image lens element 100b according to the 3rd example of the 1st embodiment of FIG. 1A. In FIG. 1K, the difference between the image lens element 100b of the 3rd example and the image lens element 100 of the 1st example is that, the third stripe structure portion 1331b has two third stripe structures (its reference numeral is omitted) in the image lens element 100b of the 3rd example. Each of the third stripe structures is disposed between the first stripe structure portion 1311b and the second stripe structure portion 1321b, wherein each of the third stripe structures is a surface structure, which extends from a first side surface 110b to a second side surface 120b.

Other structural characteristics, parameters and arrangements of the image lens element 100b of the 3rd example can be the same or similar to the image lens element 100 of the 1st example, and will not be mentioned again herein.

FIG. 1L is a partial enlarged view of the image lens element 100c according to the 4th example of the 1st embodiment of FIG. 1A. In FIG. 1L, the difference between the image lens element 100c of the 4th example and the image lens element 100 of the 1st example is that, the third stripe structure portion 1331c has two third stripe structures (its reference numeral is omitted) in the image lens element 100c of the 4th example. Each of the third stripe structures is disposed between the first stripe structure portion 1311c and the second stripe structure portion 1321c, wherein a thickness of each third stripe structure is smaller than a thickness of each first stripe structure and a thickness of each second stripe structure.

Other structural characteristics, parameters and arrangements of the image lens element 100c of the 4th example can be the same or similar to the image lens element 100 of the 1st example, and will not be mentioned again herein.

FIG. 1M is a partial enlarged view of the image lens element 100d according to the 5th example of the 1st embodiment of FIG. 1A. In FIG. 1M, the difference between the image lens element 100d of the 5th example and the image lens element 100 of the 1st example is that, the end of each first stripe structure of the first stripe structure portion 1311d, the end of each second stripe structure of the second stripe structure portion 1321d and the end of each third stripe structures of the third stripe structure portion 1331d are rounded angle.

Other structural characteristics, parameters and arrangements of the image lens element 100d of the 5th example can be the same or similar to the image lens element 100 of the 1st example, and will not be mentioned again herein.

### 2nd Embodiment

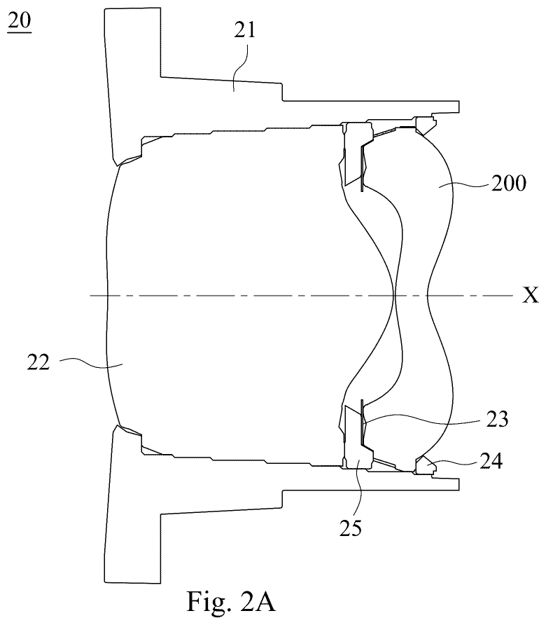

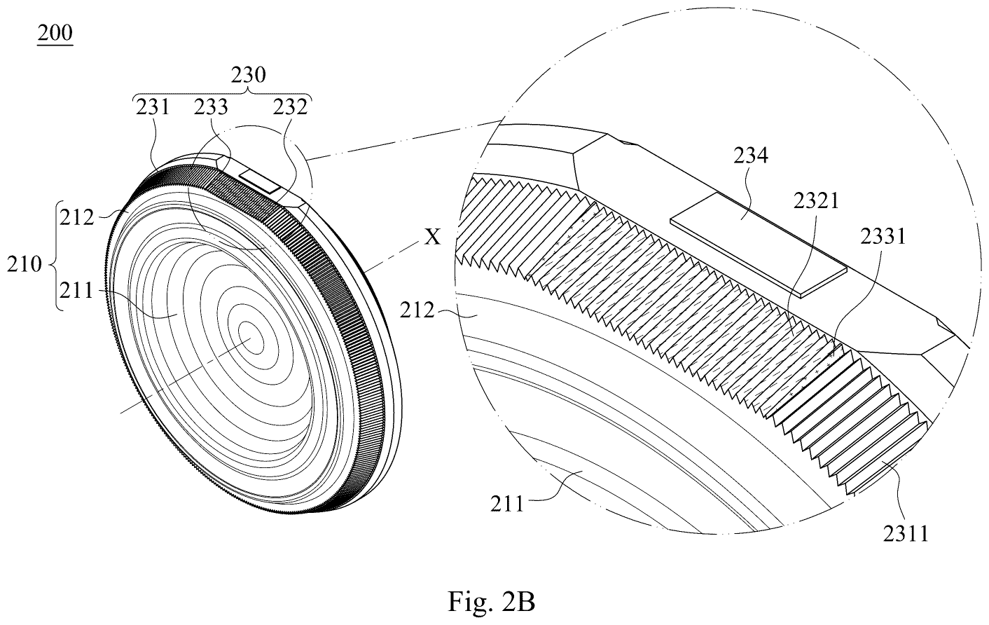

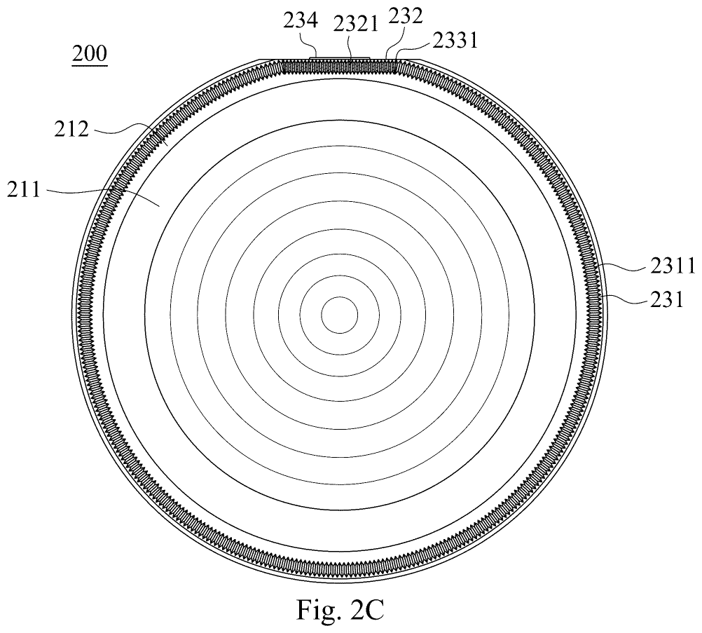

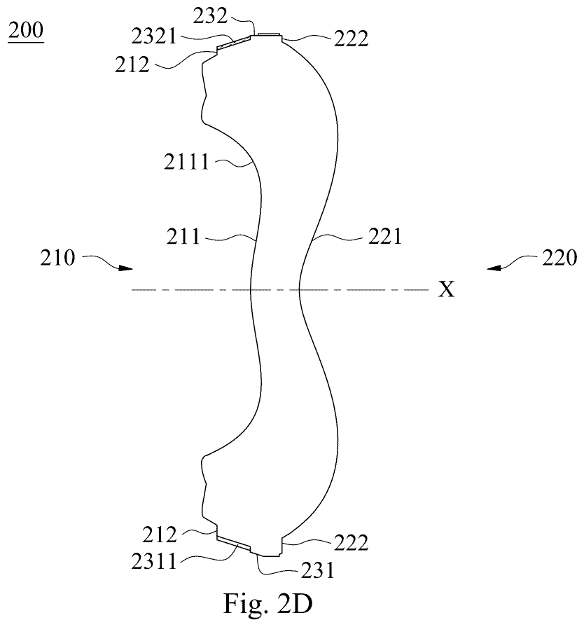

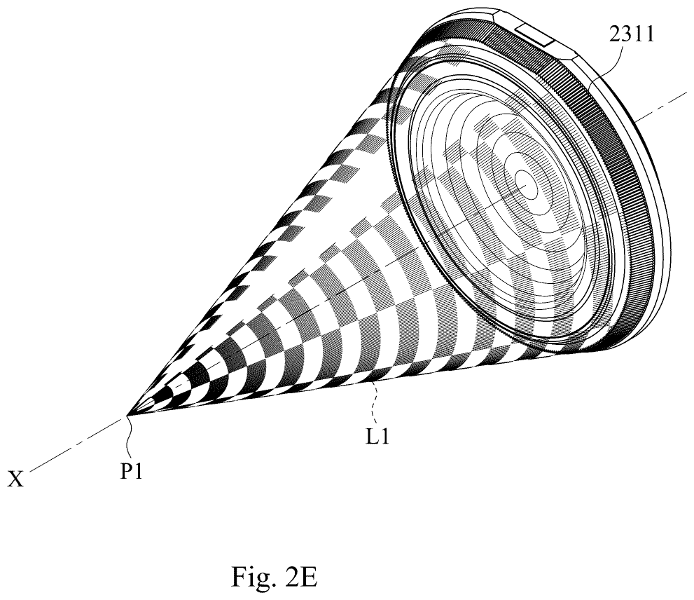

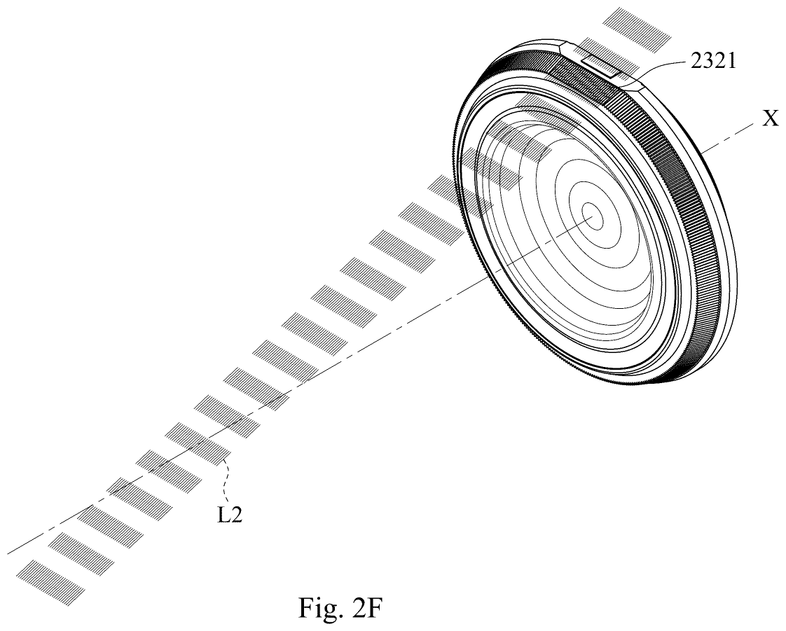

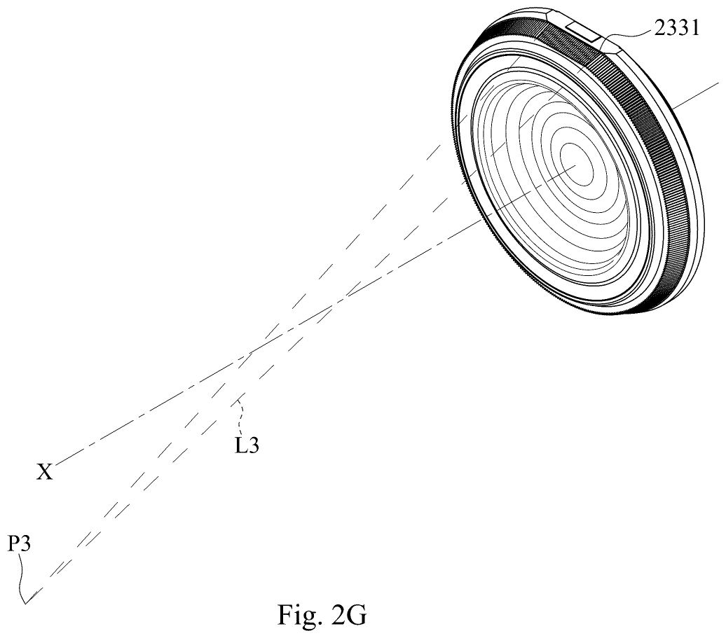

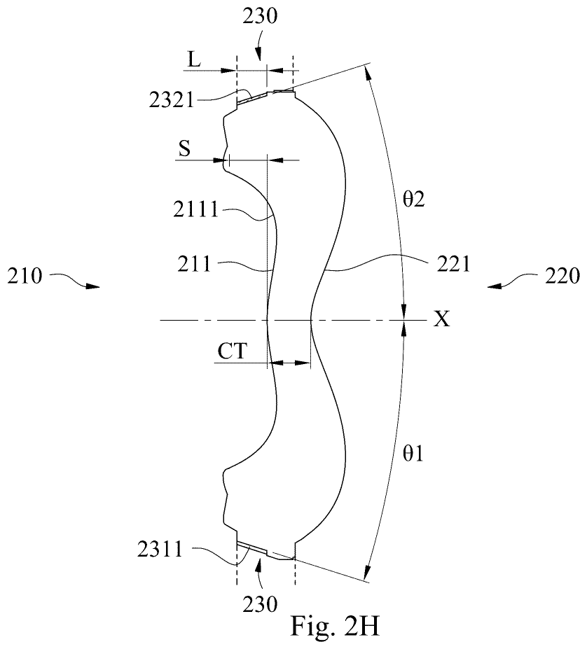

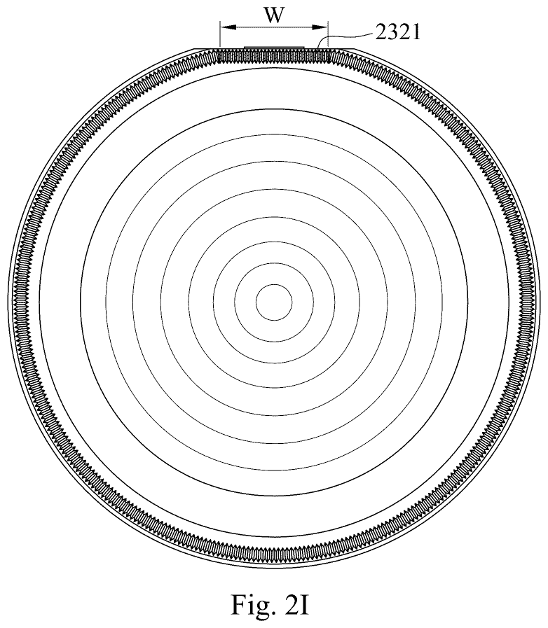

FIG. 2A is a schematic view of an imaging lens assembly 20 according to the 2nd Embodiment of the present disclosure. In FIG. 2A, the imaging lens assembly 20 includes a plastic lens barrel 21 and an imaging lens set (its reference numeral is omitted), wherein the imaging lens set is disposed in the plastic lens barrel 21. The imaging lens set includes an image lens element 200 and at least one lens element 22, wherein the image lens element 200 is made of plastic transparent material, the lens element 22 can be the image lens element of the present disclosure or other lens element with refractive power on demand, and the present disclosure will not be limited thereto. Further, the imaging lens assembly 20 can further include a light blocking sheet 23, a spacer 25 and a retainer 24, wherein, the light blocking sheet 23 and the spacer 25 can connect the lens element 22 and the image lens element 200 along the central axis X in order from the object side to the image side of the imaging lens assembly 20, and the retainer 24 can be disposed on an image side of the image lens element 200, which is for positioning the image lens element 200, however different amount or types of optical elements can be disposed on demand, the present disclosure will not be limited thereto.

FIG. 2B is a three-dimensional schematic view of the image lens element 200 according to the 1st example of the 2nd embodiment of FIG. 2A, FIG. 2C is a plane view of the image lens element 200 of FIG. 2B, and FIG. 2D is a side view of the image lens element 200 of FIG. 2B. In FIG. 2B to FIG. 2D, the image lens element 200 includes a first side surface 210, a second side surface 220 and an outer diameter surface 230. The central axis X passes through the first side surface 210 and the second side surface 220. The second side surface 220 is disposed relatively to the first side surface 210 along the central axis X. The outer diameter surface 230 is disposed between the first side surface 210 and the second side surface 220, and the outer diameter surface 230 is farther to the central axis X than each of the first side surface 210 and the second side surface 220 to the central axis X.

The first side surface 210 includes, in order from a direction farther from the central axis X, a first optical region 211 and a first peripheral region 212. The central axis X passes through a center of the first optical region 211. The first peripheral region 212 is adjacent to and connected to the first optical region 211. The second side surface 220 includes, in order from the direction farther from the central axis X, a second optical region 221 and a second peripheral region 222. The central axis X passes through a center of the second optical region 221. The second peripheral region 222 is adjacent to and connected to the second optical region 221.

The outer diameter surface 230 includes an arc region 231, a shrinking region 232 and a transition region 233. The arc region 231 is an arc-shaped centered on the central axis X and has two arc ends. The shrinking region 232 extends along a direction around the central axis X and has two end portions. The two end portions of the shrinking region 232 are corresponded to the two arc ends of the arc region 231, and the shrinking region 232 is closer to the central axis than the arc region 231 to the central axis X. The transition region 233 is disposed between the two arc ends and the two end portions, and connects the shrinking region 232 and the arc region 231. Specifically, the two end portions of the shrinking region 232 and the arc ends of the arc region 231 are disposed adjacent to each other via the transition region 233 so as to form a descend surface.

The arc region 231 includes a first stripe structure portion 2311, the first stripe structure portion 2311 has a plurality of first stripe structures (its reference numeral is omitted), which extends from the first side surface 210 to the second side surface 220, and the first stripe structures are arranged along the arc region around the central axis X. The shrinking region 232 includes a second stripe structure portion 2321, the second stripe structure portion 2321 has a plurality of second stripe structures, which extends from the first side surface 210 to the second side surface 220, and the second stripe structures are arranged from one of the two end portions to the other one of the two portions. The transition region 233 includes a third stripe structure portion 2331, the third stripe structure portion 2331 has two third stripe structures, which extends from the first side surface 210 to the second side surface 220. In FIG. 2B, each of the first stripe structures, each of the second stripe structures and each of the third stripe structures have a wedge-shaped tapered structure, and the wedge-shaped tapered structure tapers towards the direction farther from the central axis X. Further, the end of each of the first stripe structures, the end of each of the second stripe structures and the end of each of the third stripe structures are pointed angle.

FIG. 2E is a schematic view of extending lines L1 of the first stripe structures of FIG. 2B, FIG. 2F is a schematic view of extending lines L2 of the second stripe structures of FIG. 2B, and FIG. 2G is a schematic view of extending lines L3 of the third stripe structures of FIG. 2B. As shown in FIG. 2E, in the first stripe structure portion 2311, the extending lines L1 of the first stripe structures meet on one point P1 along a tapered surface, wherein, according to the 1st example of the 2nd embodiment, the point P1 is on the central axis X, but the present disclosure will not be limited thereto. As shown in FIG. 2F, in the second stripe structure portion 2321, the extending lines L2 of the second stripe structures do not meet with each other on two extending directions of a plane, but the present disclosure will not be limited thereto. As shown in FIG. 2G, in the third stripe structure portion 2331, the extending lines L3 of the third stripe structures meet with each other on one point P3, wherein, according to the 1st example of the 2nd embodiment, the point P3 deviates the central axis X. Moreover, as shown in both of FIG. 2E and FIG. 2G, the extending lines L3 of the third stripe structures meet with each other on a third location (that is, the point P3), the extending lines L1 of the first stripe structures meet with each other on a first location (that is, the point P1), and the third location (that is, the point P3) and the first location (that is, the point P1) are different.

In FIG. 2D, the first optical region 211 has a concave portion 2111, wherein the concave portion 2111 is disposed relative to the first stripe structure portion 2311 and the second stripe structure portion 2321 along the direction farther from the central axis X.

FIG. 2H and FIG. 2I are schematic views of parameters of the image lens element 200 of FIG. 2B, respectively. In FIG. 2H and FIG. 2I, according to the 1st example of the 2nd embodiment, when a first angle is formed between the first stripe structure portion 2311 and the central axis X, the first angle is θ1, a second angle is formed between the second stripe structure portion 2321 and the central axis X, the second angle is θ2, a length of the second stripe structure portion 2321 along the central axis X is L, a length of the second stripe structure portion 2321 along the one of the two end portions to the other one of the two portions is W, a distance along the central axis X between a center to an edge of the one of the first optical region 211 and the second optical region 221 having the concave portion 2111 (according to the 1st example of the 2nd embodiment, that is the first optical region 211) is S, and a distance between the center of the first optical region 211 and the center of the second optical region 221 is CT, the data in the following Table 2A are satisfied.

TABLE 2A
1st example of the 2nd embodiment

| θ1 | (degrees) | 18 | L/W | | 0.307 |
|---|---|---|---|---|---|
| θ2 | (degrees) | 18 | S | (mm) | 0.492 |
| L | (mm) | 0.390 | CT | (mm) | 0.571 |

| | | | | |
|---|---|---|---|---|
| W | (mm) | 1.269 | S/CT | 0.862 |

### 3rd Embodiment

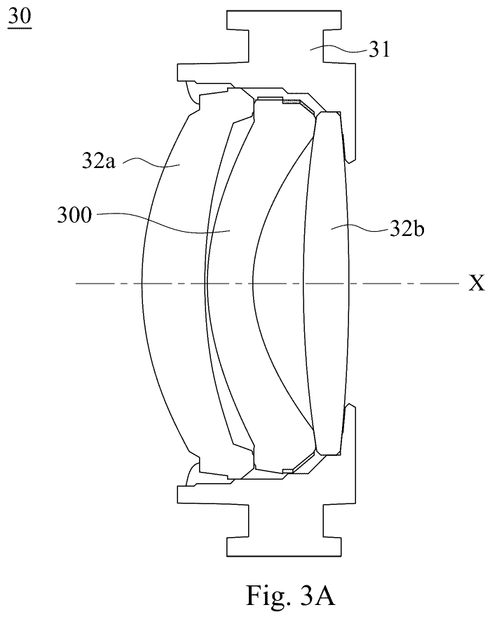

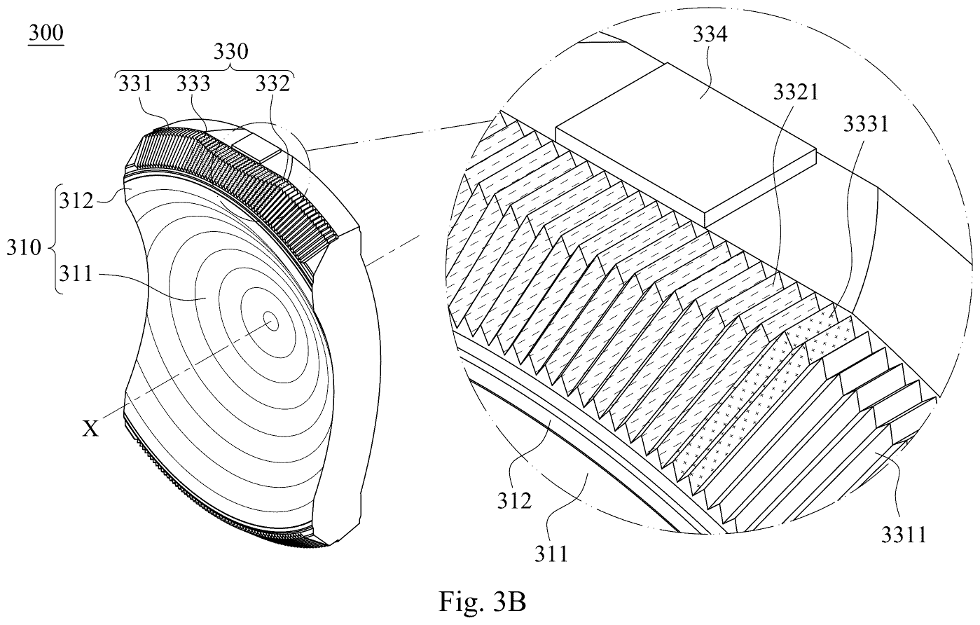

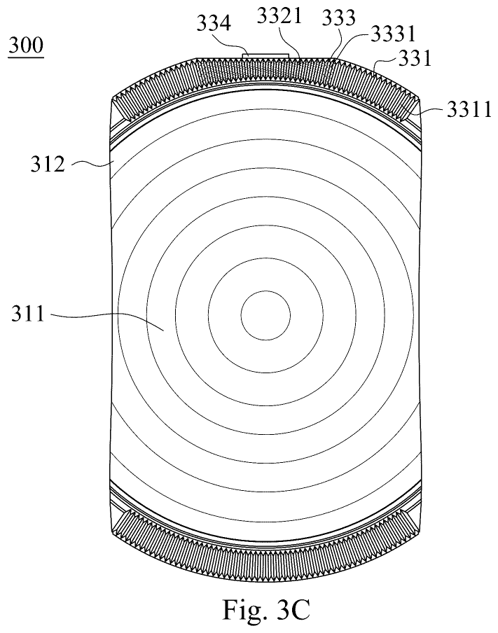

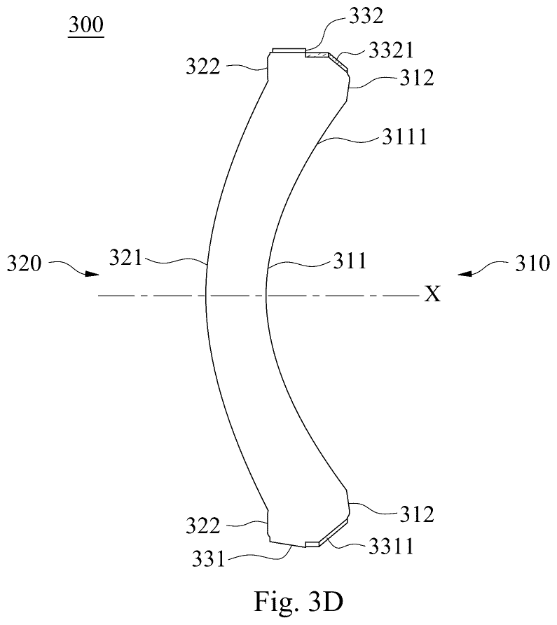

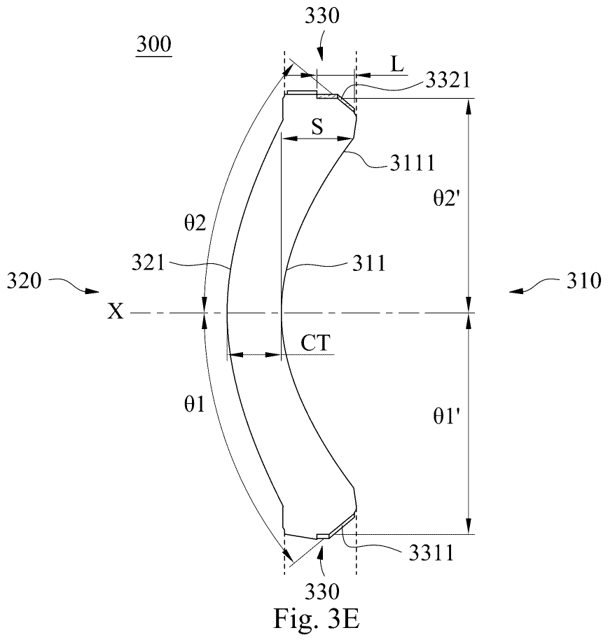

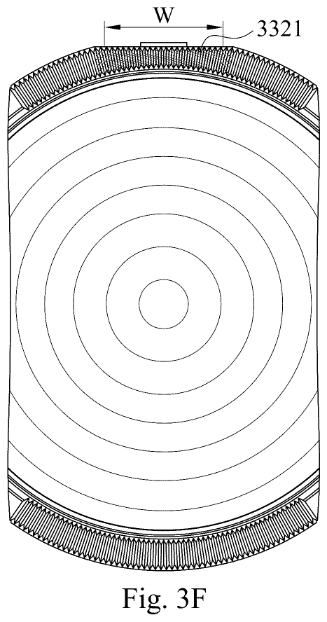

FIG. 3A is a schematic view of an imaging lens assembly 30 according to the 3rd Embodiment of the present disclosure. In FIG. 3A, the imaging lens assembly 30 includes a plastic lens barrel 31 and an imaging lens set (its reference numeral is omitted), wherein the imaging lens set is disposed in the plastic lens barrel 31. The imaging lens set includes an image lens element 300 and two lens elements 32a, 32b, wherein the image lens element 300 is made of plastic transparent material, the lens elements 32a, 32b can be the image lens element of the present disclosure or other lens element with refractive power on demand, and the present disclosure will not be limited thereto. The lens element 32a, the image lens element 300 and the lens element 32b can be disposed in the plastic lens barrel 31 along the central axis X in order from the object side to the image side of the imaging lens assembly 30. Further, the imaging lens assembly 30 can further include different amount or types of optical elements can be disposed on demand, the present disclosure will not be limited thereto.

FIG. 3B is a three-dimensional schematic view of the image lens element 300 according to the 1st example of the 3rd embodiment of FIG. 3A, FIG. 3C is a plane view of the image lens element 300 of FIG. 3B, and FIG. 3D is a side view of the image lens element 300 of FIG. 3B. In FIG. 3B to FIG. 3D, the image lens element 300 includes a first side surface 310, a second side surface 320 and an outer diameter surface 330. The central axis X passes through the first side surface 310 and the second side surface 320. The second side surface 320 is disposed relatively to the first side surface 310 along the central axis X. The outer diameter surface 330 is disposed between the first side surface 310 and the second side surface 320, and the outer diameter surface 330 is farther to the central axis X than each of the first side surface 310 and the second side surface 320 to the central axis X.

The first side surface 310 includes, in order from a direction farther from the central axis X, a first optical region 311 and a first peripheral region 312. The central axis X passes through a center of the first optical region 311. The first peripheral region 312 is adjacent to and connected to the first optical region 311. The second side surface 320 includes, in order from the direction farther from the central axis X, a second optical region 321 and a second peripheral region 322. The central axis X passes through a center of the second optical region 321. The second peripheral region 322 is adjacent to and connected to the second optical region 321.

The outer diameter surface 330 includes an arc region 331, a shrinking region 332 and a transition region 333. The arc region 331 is an arc-shaped centered on the central axis X and has two arc ends. The shrinking region 332 extends along a direction around the central axis X and has two end portions. The two end portions of the shrinking region 332 are corresponded to the two arc ends of the arc region 331, and the shrinking region 332 is closer to the central axis than the arc region 331 to the central axis X. The transition region 333 is disposed between the two arc ends and the two end portions, and connects the shrinking region 332 and the arc region 331. Specifically, the two end portions of the shrinking region 332 and the arc ends of the arc region 331 are disposed adjacent to each other via the transition region 333 so as to form a descend surface.

It should be mentioned that the image lens element 300 of FIG. 3B has shrinking surfaces, which separate the arc region 331 into three sections, but the arc region 331 can still be deemed as a continuous arc-shaped centered on the central axis X.

The arc region 331 includes a first stripe structure portion 3311, the first stripe structure portion 3311 has a plurality of first stripe structures (its reference numeral is omitted), which extends from the first side surface 310 to the second side surface 320, and the first stripe structures are arranged along the arc region 331 around the central axis X. The shrinking region 332 includes a second stripe structure portion 3321, the second stripe structure portion 3321 has a plurality of second stripe structures (its reference numeral is omitted), which extends from the first side surface 310 to the second side surface 320, and the second stripe structures are arranged from one of the two end portions to the other one of the two portions. The transition region 333 includes a third stripe structure portion 3331, the third stripe structure portion 3331 has four third stripe structures (its reference numeral is omitted), which extends from the first side surface 310 to the second side surface 320. In FIG. 3B, each of the first stripe structures, each of the second stripe structures and each of the third stripe structures have a wedge-shaped tapered structure, and the wedge-shaped tapered structure tapers towards the direction farther from the central axis X. Further, the end of each of the first stripe structures, the end of each of the second stripe structures and the end of each of the third stripe structures are pointed angle.

In FIG. 3D, the first optical region 311 has a concave portion 3111, wherein the concave portion 3111 is disposed relative to the first stripe structure portion 3311 and the second stripe structure portion 3321 along the direction farther from the central axis X.

FIG. 3E and FIG. 3F are schematic views of parameters of the image lens element 300 of FIG. 3B, respectively. In FIG. 3E and FIG. 3F, according to the 1st example of the 3rd embodiment, when a first angle is formed between the first stripe structure portion 3311 and the central axis X, the first angle is θ1, θ1′, respectively, a second angle is formed between the second stripe structure portion 3321 and the central axis X, the second angle is θ2, θ2′, respectively, a length of the second stripe structure portion 3321 along the central axis X is L, a length of the second stripe structure portion 3321 along the one of the two end portions to the other one of the two portions is W, a distance along the central axis X between a center to an edge of the one of the first optical region 311 and the second optical region 321 having the concave portion 3111 (according to the 1st example of the 3rd embodiment, that is the first optical region 311) is S, and a distance between the center of the first optical region 311 and the center of the second optical region 321 is CT, the data in the following Table 3A are satisfied.

TABLE 3A
1st example of the 3rd embodiment

| θ1 | (degrees) | 40 | W | (mm) | 2.043 |
|---|---|---|---|---|---|
| θ2 | (degrees) | 40 | L/W | | 0.372 |
| θ1′ | (degrees) | 0 | S | (mm) | 1.460 |
| θ2′ | (degrees) | 0 | CT | (mm) | 1.100 |

| | | | | |
|---|---|---|---|---|
| L | (mm) | 0.760 | S/CT | 1.327 |

It should be mentioned that, according to the 1st example of the 3rd embodiment, the first angle refers two values, which are θ1, θ1′, but the definition thereof are the same with the angle θ1 in the present disclosure; the second angle refers two values, which are θ2, θ2′, but the definition thereof are the same with the angle θ2 in the present disclosure.

### 4th Embodiment

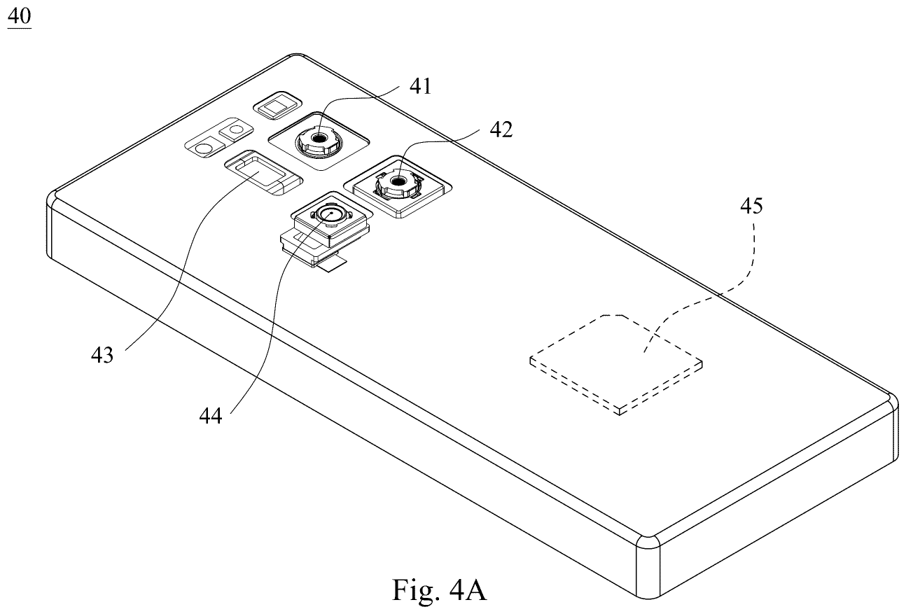

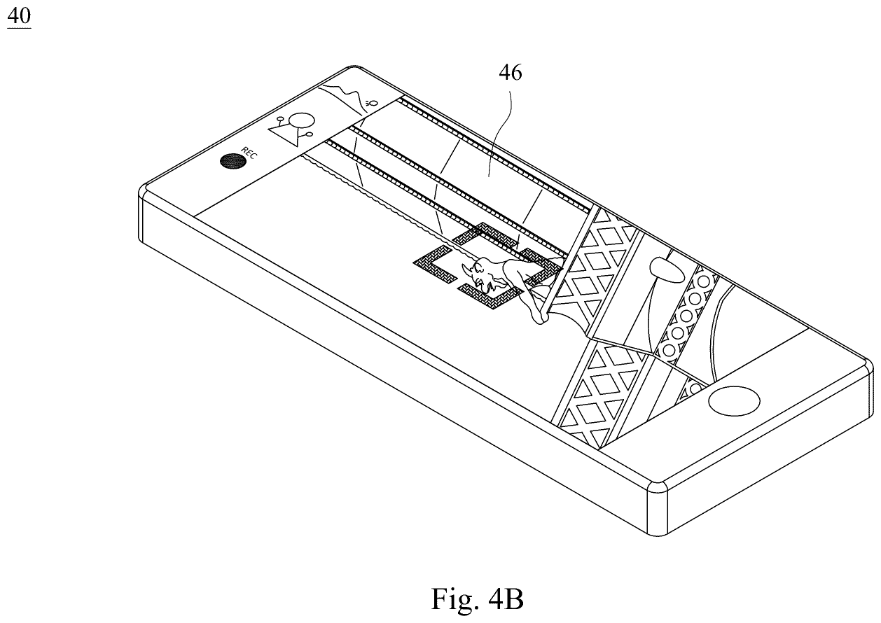

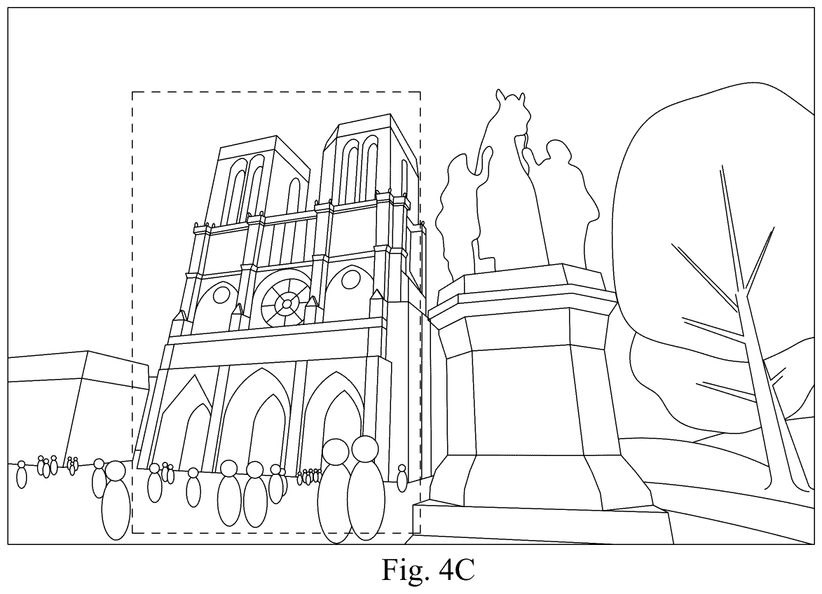

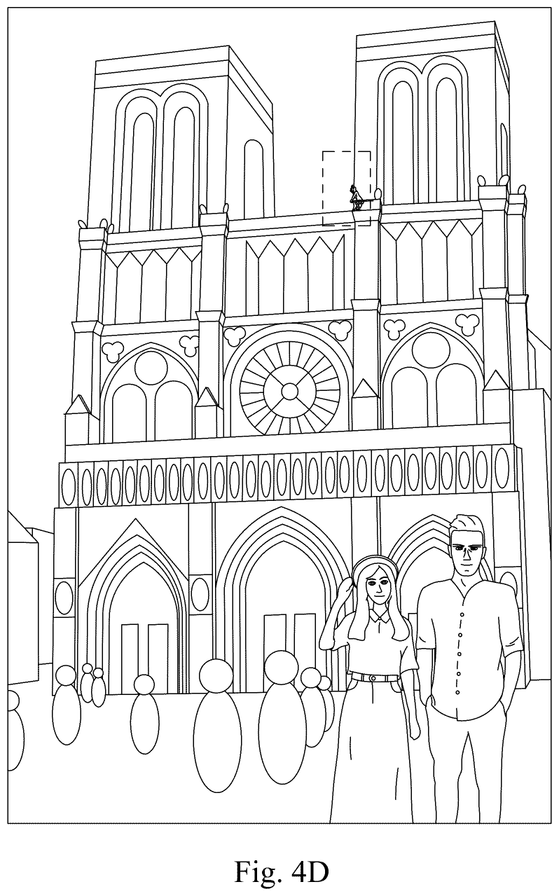

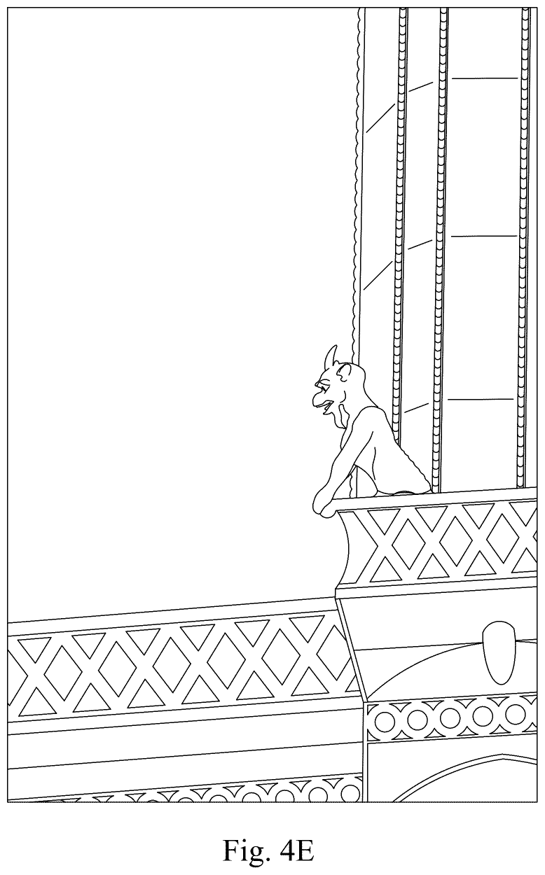

FIG. 4A is a schematic view of an electronic device 40 according to the 4th embodiment of the present disclosure. FIG. 4B is another schematic view of the electronic device 40 according to the 4th embodiment of FIG. 4A. As shown in FIG. 4A and FIG. 4B, the electronic device 40 is a smartphone. The electronic device 40 includes camera modules and a user interface 46, wherein each camera module can includes the imaging lens assembly according to any example according to the aforementioned 1st to 3rd embodiments. In detail, the camera modules are a high-pixel camera module 41, an ultra-wide-angle camera module 42, and two telephoto camera modules 43, 44, and the user interface 46 is a touch screen, but the present disclosure is not limited thereto.

A user enters a shooting mode via the user interface 46. The user interface 46 is used to display the screen, and the shooting angle can be manually adjusted to switch between different camera modules. At this moment, the camera modules collect an imaging light on the respective image sensor (not shown in figures) and output electronic signals associated with images to an image signal processor (ISP) 45.

As shown in FIG. 4A, according to the camera specifications of the electronic device 40, the electronic device 40 can further include an optical anti-shake mechanism (not shown in figures). Further, the electronic device 40 can further include at least one focusing assisting module (not shown in figures) and at least one sensing component (not shown in figures). The focusing assisting module can be a flash module, an infrared distance measurement component, a laser focus module, etc. The flash module is for compensating the color temperature. The sensing component can have functions for sensing physical momentum and kinetic energies, such as an accelerator, a gyroscope, and a Hall effect element, so as to sense shaking or jitters applied by hands of the user or external environments. Thus the autofocus function and the optical anti-shake mechanism of the imaging lens assembly disposed on the electronic device 40 can function to obtain a great image quality and facilitate the electronic device 40 according to the present disclosure to have a capturing function with multiple modes, such as taking optimized selfies, high dynamic range (HDR) with a low light source, 4K resolution recording, etc. Furthermore, the user can visually see the captured image of the camera through the user interface 46 and manually operate the view finding range on the user interface 46 to achieve the auto focus function of what you see is what you get.

Furthermore, the camera modules, the optical anti-shake mechanism, the sensing component and the focusing assisting module can be disposed on a flexible printed circuit board (FPC) (not shown in figures) and electrically connected to the image signal processor 45 and so on via a connector (not shown in figures) so as to operate a picturing process. Recent electronic devices such as smartphones have a trend towards thinness and lightness. The camera modules and the related elements are disposed on a FPC and circuits are assembled into a main board of an electronic device by a connector. Hence, it can fulfill a mechanical design of a limited inner space of the electronic device and a requirement of a circuit layout and obtain a larger allowance, and it is also favorable for autofocus functions of the camera modules obtaining a flexible control via a touch screen of the electronic device. In the 4th embodiment, the electronic device 40 can include a plurality of the sensing components and a plurality of the focusing assisting modules, and the sensing components and the focusing assisting modules are disposed on an FPC and another at least one FPC (not shown in figures) and electrically connected to the image signal processor 45 and so on via a corresponding connector so as to operate a picturing process. In other embodiments (not shown in figures), the sensing components and auxiliary optical elements can be disposed on a main board of an electronic device or a board of the other form according to a mechanical design and a requirement of a circuit layout.

Furthermore, the electronic device 40 can further include, but not be limited to, a display, a control unit, a storage unit, a random-access memory (RAM), a read-only memory (ROM), or the combination thereof.

FIG. 4C is a schematic view of an image captured via the electronic device 40 according to the 4th embodiment of FIG. 4A. As shown in FIG. 4C, a larger ranged image can be captured via the ultra-wide-angle camera module 42, which has a function for containing more views.

FIG. 4D is another schematic view of the image captured via the electronic device 40 according to the 4th embodiment of FIG. 4A. As shown in FIG. 4D, a certain ranged and high-pixel image can be captured via the high-pixel camera module 41, which has a function for high resolution and low distortion.

FIG. 4E is the other schematic view of the image captured via the electronic device 40 according to the 4th embodiment of FIG. 4A. As shown in FIG. 4E, a far image can be captured and enlarged to a high magnification via the telephoto camera modules 43, 44, which has a function for a high magnification.

As shown in FIG. 4C to FIG. 4E, when an image is captured via different camera modules having various focal lengths and processed via a technology of an image processing, a zoom function of the electronic device 40 can be achieved.

### 5th Embodiment

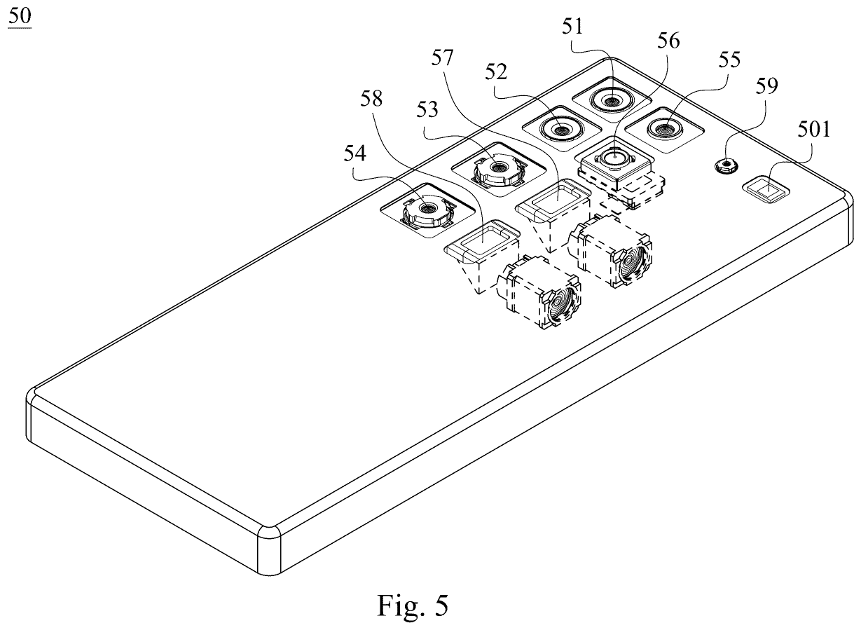

FIG. 5 is a schematic view of an electronic device 50 according to the 5th embodiment of the present disclosure. As shown in FIG. 5, the electronic device 50 is a smartphone. The electronic device 50 includes a plurality of camera modules, wherein each camera module can includes the imaging lens assembly according to any example according to the aforementioned 1st to 3rd embodiments, but the present disclosure is not limited thereto. In detail, camera modules are two ultra-wide-angle camera modules 51, 52, two wide angle camera modules 53, 54, four telephoto camera modules 55, 56, 57, 58, and a Time-Of-Flight (TOF) module 59, the TOF module 59 can be other types of camera module, which will not be limited to the present arrangement.

Further, the camera modules 57, 58 can have folding function of the light path, but the present disclosure will not be limited thereto.

According to the camera specifications of the electronic device 50, the electronic device 50 can further include an optical anti-shake mechanism (not shown in figures). Further, the electronic device 50 can further include at least one focusing assisting module (not shown in figures) and at least one sensing component (not shown in figures). The focusing assisting module can be a flash module 501, an infrared distance measurement component, a laser focus module, etc. The flash module 501 is for compensating the color temperature. The sensing component can have functions for sensing physical momentum and kinetic energies, such as an accelerator, a gyroscope, and a Hall effect element, so as to sense shaking or jitters applied by hands of the user or external environments. Thus, the autofocus function and the optical anti-shake mechanism of the camera modules disposed on the electronic device 50 can function to obtain a great image quality and facilitate the electronic device 50 according to the present disclosure to have a capturing function with multiple modes, such as taking optimized selfies, high dynamic range (HDR) with a low light source, 4K resolution recording, etc.

Furthermore, all of other structures and dispositions according to the 5th embodiment are the same as the structures and the dispositions according to the 4th embodiment, and will not be described again herein.

### 6th Embodiment

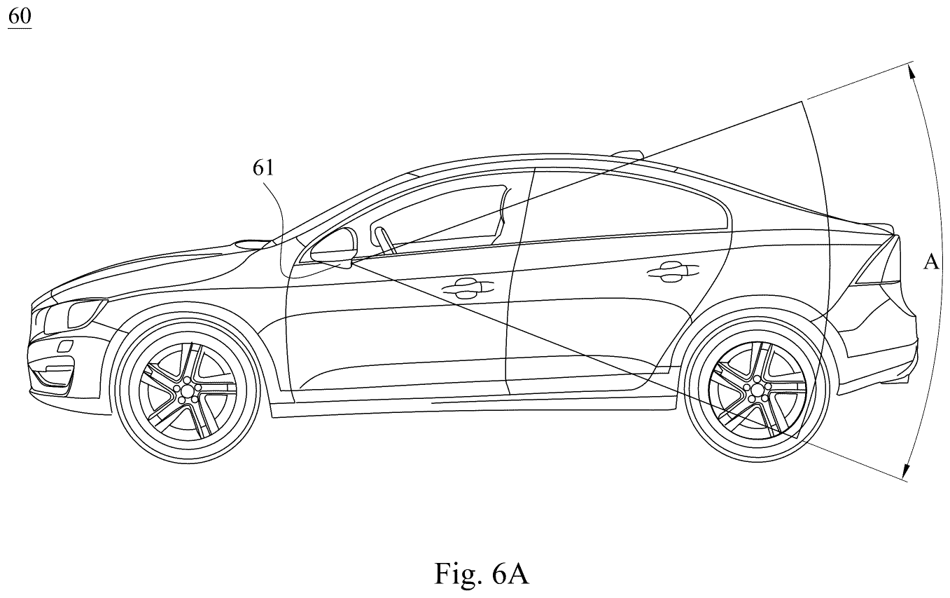

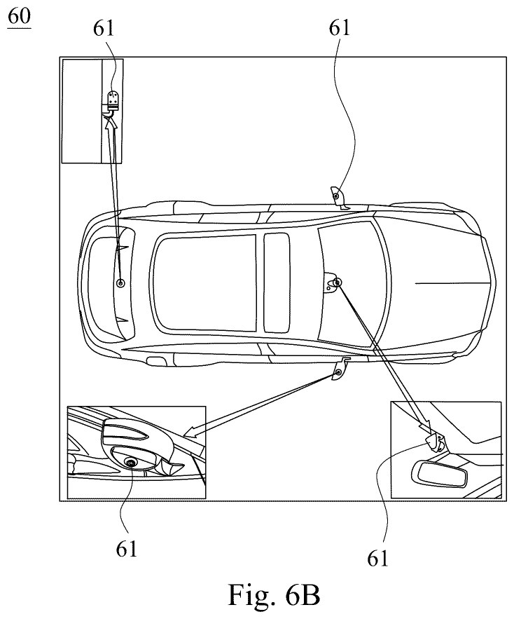

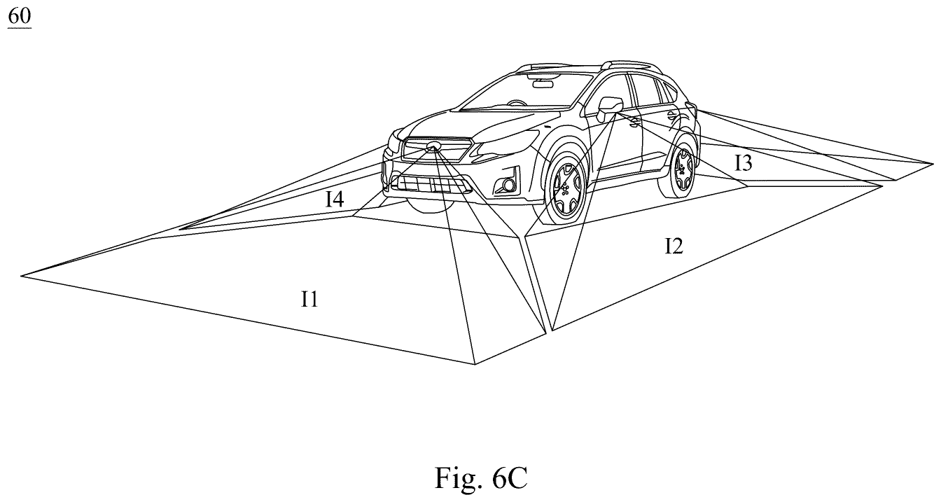

FIG. 6A is a schematic view of a vehicle instrument 60 according to the 6th embodiment of the present disclosure. FIG. 6B is another schematic view of the vehicle instrument 60 according to the 6th embodiment in FIG. 6A. FIG. 6C is another schematic view of the vehicle instrument 60 according to the 6th embodiment in FIG. 6A. In FIGS. 6A to 6C, the vehicle instrument 60 includes a plurality of camera modules 61. According to the 6th embodiment, a number of the camera modules 61 is six, and the camera modules 61 can include the imaging lens assembly according to any example according to the aforementioned 1st to 3rd embodiments, but the present disclosure is not limited thereto.

In FIGS. 6A and 6B, the camera modules 61 are automotive camera modules, two of the camera modules 61 are located under rearview mirrors on a left side and a right side, respectively, and the aforementioned camera modules 810 are configured to capture the image information of a visual angle A. In particular, the visual angle A can satisfy the following condition: 40 degrees<A<90 degrees. Therefore, the image information in the regions of two lanes on the left side and the right side can be captured.

In FIG. 6B, another two of the camera modules 61 can be disposed in the inner space of the vehicle instrument 60. In particular, the aforementioned two camera modules 61 are disposed on a location close to the rearview mirror inside the vehicle instrument 60 and a location close to the rear car window, respectively. Moreover, the camera modules 61 can be further disposed on the rearview mirrors of the vehicle instrument 60 on the left side and the right side except the mirror surface, respectively, but the present disclosure is not limited thereto.

In FIG. 6C, another two of the camera modules 61 can be disposed on a front end of the vehicle instrument 60 and a rear end of the vehicle instrument 60, respectively. By disposing the camera modules 61 on the front end and the rear end of the vehicle instrument 60 and under the rearview mirror on the left side of the vehicle instrument 60 and the right side of the vehicle instrument 60, it is favorable for the drivers obtaining the external space information in addition to the driving seat, such as the external space informations 11, 12, 13, 14, but the present disclosure is not limited thereto. Therefore, more visual angles can be provided to reduce the blind spot, so that the driving safety can be improved. Further, the traffic information outside of the vehicle instrument 60 can be recognized by disposing the camera modules 61 on the periphery of the vehicle instrument 60, so that the function of the automatic driving assistance can be achieved.

The foregoing description, for purpose of explanation, has been described with reference to specific examples. It is to be noted that Tables show different data of the different examples; however, the data of the different examples are obtained from experiments. The examples were chosen and described in order to best explain the principles of the disclosure and its practical applications, to thereby enable others skilled in the art to best utilize the disclosure and various examples with various modifications as are suited to the particular use contemplated. The examples depicted above and the appended drawings are exemplary and are not intended to be exhaustive or to limit the scope of the present disclosure to the precise forms disclosed. Many modifications and variations are possible in view of the above teachings.

What is claimed is:

1. An image lens element, having a central axis, comprising:
a first side surface, the central axis passing through the first side surface, the first side surface comprising, in order from a direction farther from the central axis:
a first optical region, the central axis passing through a center of the first optical region; and
a first peripheral region adjacent to and connected to the first optical region;
a second side surface disposed relatively to the first side surface along the central axis, the second side surface comprising, in order from the direction farther from the central axis:
a second optical region, the central axis passing through a center of the second optical region; and
a second peripheral region adjacent to and connected to the second optical region; and
an outer diameter surface disposed between the first side surface and the second side surface, wherein the outer diameter surface is farther to the central axis than each of the first side surface and the second side surface to the central axis, the outer diameter surface comprising:
an arc region being an arc-shaped centered on the central axis and having two arc ends, wherein the arc region comprises a first stripe structure portion, the first stripe structure portion has a plurality of first stripe structures, which extends from the first side surface to the second side surface, and the first stripe structures are arranged along the arc region around the central axis;
a shrinking region extending along a direction around the central axis and having two end portions, the two end portions of the shrinking region corresponded to the two arc ends of the arc region, and the shrinking region being closer to the central axis than the arc region to the central axis, wherein the shrinking region comprises a second stripe structure portion, the second stripe structure portion has a plurality of second stripe structures, which extends from the first side surface to the second side surface, and the second stripe structures are arranged from one of the two end portions to the other one of the two portions;
wherein an extending line of each of the first stripe structures meets on one point along a tapered surface, an extending line of each of the second stripe structures does not meet with each other on two extending directions of a plane.

2. The image lens element of claim 1, wherein each of the first stripe structures and each of the second stripe structures have a wedge-shaped tapered structure, and the wedge-shaped tapered structure tapers towards the direction farther from the central axis.

3. The image lens element of claim 1, wherein the outer diameter surface further comprises:
a gate trace disposed on the shrinking region, wherein the gate trace is disposed adjacent to the second stripe structure portion along a direction of the central axis.

4. The image lens element of claim 1, wherein a first angle is formed between the first stripe structure portion and the central axis, the first angle is θ1, and the following condition is satisfied:
$$0 degrees \leq θ1 \leq 45 degrees .$$

5. The image lens element of claim 4, wherein the first angle is formed between the first stripe structure portion and the central axis, the first angle is θ1, and the following condition is satisfied:
$$0 degrees \leq θ1 \leq 25 degrees .$$

6. The image lens element of claim 1, wherein a second angle is formed between the second stripe structure portion and the central axis, the second angle is θ2, and the following condition is satisfied:
$$0 degrees \leq θ2 \leq 45 degrees .$$

7. The image lens element of claim 6, wherein the second angle is formed between the second stripe structure portion and the central axis, the second angle is θ2, and the following condition is satisfied:
$$0 degrees \leq θ2 \leq 25 degrees .$$

8. The image lens element of claim 1, wherein a length of the second stripe structure portion along the central axis is L, a length of the second stripe structure portion along the one of the two end portions to the other one of the two portions is W, and the following condition is satisfied:
$$0.1 < L / W < 1.1 .$$

9. The image lens element of claim 8, wherein the length of the second stripe structure portion along the central axis is L, the length of the second stripe structure portion along the one of the two end portions to the other one of the two portions is W, and the following condition is satisfied:
$$0.15 < L / W < 0.85 .$$

10. The image lens element of claim 1, wherein one of the first optical region and the second optical region has a concave portion.

11. The image lens element of claim 10, wherein the concave portion is disposed relative to the first stripe structure portion and the second stripe structure portion along the direction farther from the central axis.

12. The image lens element of claim 10, wherein a distance along the central axis between a center to an edge of the one of the first optical region and the second optical region having the concave portion is S, a distance between the center of the first optical region and the center of the second optical region is CT, and the following condition is satisfied:
$$0.6 < S / CT < 2.7 .$$

13. The image lens element of claim 12, wherein the distance along the central axis between the center to the edge of the one of the first optical region and the second optical region having the concave portion is S, the distance between the center of the first optical region and the center of the second optical region is CT, and the following condition is satisfied:
$$0.7 < S / CT < 2.3 .$$

14. An imaging lens assembly, comprising:
a plastic lens barrel; and
an imaging lens set disposed in the plastic lens barrel, and comprising at least one of the image lens element of claim 1.

15. An electronic device, comprising:
the imaging lens assembly of claim 14.

16. An image lens element, having a central axis, comprising:
a first side surface, the central axis passing through the first side surface, the first side surface comprising, in order from a direction farther from the central axis:
a first optical region, the central axis passing through a center of the first optical region; and
a first peripheral region adjacent to and connected to the first optical region;
a second side surface disposed relatively to the first side surface along the central axis, the second side surface comprising, in order from the direction farther from the central axis:
a second optical region, the central axis passing through a center of the second optical region; and
a second peripheral region adjacent to and connected to the second optical region; and
an outer diameter surface disposed between the first side surface and the second side surface, wherein the outer diameter surface is farther to the central axis than each of the first side surface and the second side surface to the central axis, the outer diameter surface comprising:
an arc region being an arc-shaped centered on the central axis and having two arc ends, wherein the arc region comprises a first stripe structure portion, the first stripe structure portion has a plurality of first stripe structures, which extends from the first side surface to the second side surface, and the first stripe structures are arranged along the arc region around the central axis;
a shrinking region extending along a direction around the central axis and having two end portions, the two end portions of the shrinking region corresponded to the two arc ends of the arc region, and the shrinking region being closer to the central axis than the arc region to the central axis, wherein the shrinking region comprises a second stripe structure portion, the second stripe structure portion has a plurality of second stripe structures, which extends from the first side surface to the second side surface, and the second stripe structures are arranged from one of the two end portions to the other one of the two portions;
wherein, the outer diameter surface further comprises a gate trace disposed on the shrinking region, wherein the gate trace is disposed adjacent to the second stripe structure portion along a direction of the central axis.

17. The image lens element of claim 16, wherein each of the first stripe structures and each of the second stripe structures have a wedge-shaped tapered structure, and the wedge-shaped tapered structure tapers towards the direction farther from the central axis.

18. The image lens element of claim 16, wherein a second angle is formed between the second stripe structure portion and the central axis, the second angle is θ2, and the following condition is satisfied:
$$0 degrees \leq θ2 \leq 45 degrees .$$

19. The image lens element of claim 18, wherein the second angle is formed between the second stripe structure portion and the central axis, the second angle is θ2, and the following condition is satisfied:
$$0 degrees \leq θ2 \leq 25 degrees .$$

20. The image lens element of claim 16, wherein a length of the second stripe structure portion along the central axis is L, a length of the second stripe structure portion along the one of the two end portions to the other one of the two portions is W, and the following condition is satisfied:
$$0.1 < L / W < 1.1 .$$

21. The image lens element of claim 20, wherein the length of the second stripe structure portion along the central axis is L, the length of the second stripe structure portion along the one of the two end portions to the other one of the two portions is W, and the following condition is satisfied:
$$0.15 < L / W < 0.85 .$$

22. The image lens element of claim 16, wherein one of the first optical region and the second optical region has a concave portion.

23. The image lens element of claim 22, wherein the concave portion is disposed relative to the first stripe structure portion and the second stripe structure portion along the direction farther from the central axis.

24. The image lens element of claim 22, wherein a distance along the central axis between a center to an edge of the one of the first optical region and the second optical region having the concave portion is S, a distance between the center of the first optical region and the center of the second optical region is CT, and the following condition is satisfied:
$$0.6 < S / CT < 2.7 .$$

25. The image lens element of claim 24, wherein the distance along the central axis between the center to the edge of the one of the first optical region and the second optical region having the concave portion is S, the distance between the center of the first optical region and the center of the second optical region is CT, and the following condition is satisfied:
$$0.7 < S / CT < 2.3 .$$

26. An image lens element, having a central axis, comprising:
a first side surface, the central axis passing through the first side surface, the first side surface comprising, in order from a direction farther from the central axis:
a first optical region, the central axis passing through a center of the first optical region; and
a first peripheral region adjacent to and connected to the first optical region;
a second side surface disposed relatively to the first side surface along the central axis, the second side surface comprising, in order from the direction farther from the central axis:
a second optical region, the central axis passing through a center of the second optical region; and
a second peripheral region adjacent to and connected to the second optical region; and
an outer diameter surface disposed between the first side surface and the second side surface, wherein the outer diameter surface is farther to the central axis than each of the first side surface and the second side surface to the central axis, the outer diameter surface comprising:
an arc region being an arc-shaped centered on the central axis and having two arc ends, wherein the arc region comprises a first stripe structure portion, the first stripe structure portion has a plurality of first stripe structures, which extends from the first side surface to the second side surface, and the first stripe structures are arranged along the arc region around the central axis;
a shrinking region extending along a direction around the central axis and having two end portions, the two end portions of the shrinking region corresponded to the two arc ends of the arc region, and the shrinking region being closer to the central axis than the arc region to the central axis, wherein the shrinking region comprises a second stripe structure portion, the second stripe structure portion has a plurality of second stripe structures, which extends from the first side surface to the second side surface, and the second stripe structures are arranged from one of the two end portions to the other one of the two portions;
wherein, the outer diameter surface further comprises a transition region disposed between the two arc ends and the two end portions, and connecting the shrinking region and the arc region, wherein the transition region comprises a third stripe structure portion, the third stripe structure portion has at least two third stripe structures, which extends from the first side surface to the second side surface, an extending line of each of the at least two third stripe structures meets with each other on a third location, an extending line of each of the first stripe structures meets with each other on a first location, and the third location and the first location are different.

27. The image lens element of claim 26, wherein each of the first stripe structures and each of the second stripe structures have a wedge-shaped tapered structure, and the wedge-shaped tapered structure tapers towards the direction farther from the central axis.

28. The image lens element of claim 26, wherein each of the at least two third stripe structures has a wedge-shaped tapered structure, and the wedge-shaped tapered structure tapers towards the direction farther from the central axis.

29. The image lens element of claim 26, wherein a length of the second stripe structure portion along the central axis is L, a length of the second stripe structure portion along the one of the two end portions to the other one of the two portions is W, and the following condition is satisfied:
$$0.1 < L / W < 1.1 .$$

30. The image lens element of claim 29, wherein the length of the second stripe structure portion along the central axis is L, the length of the second stripe structure portion along the one of the two end portions to the other one of the two portions is W, and the following condition is satisfied:
$$0.15 < L / W < 0.85 .$$

31. The image lens element of claim 26, wherein a first angle is formed between the first stripe structure portion and the central axis, the first angle is θ1, and the following condition is satisfied:
$$0 degrees \leq θ1 \leq 45 degrees .$$

32. The image lens element of claim 31, wherein the first angle is formed between the first stripe structure portion and the central axis, the first angle is θ1, and the following condition is satisfied:
$$0 degrees \leq θ1 \leq 25 degrees .$$

33. An image lens element, having a central axis, comprising:
a first side surface, the central axis passing through the first side surface, the first side surface comprising, in order from a direction farther from the central axis:
a first optical region, the central axis passing through a center of the first optical region; and
a first peripheral region adjacent to and connected to the first optical region;
a second side surface disposed relatively to the first side surface along the central axis, the second side surface comprising, in order from the direction farther from the central axis:
a second optical region, the central axis passing through a center of the second optical region; and
a second peripheral region adjacent to and connected to the second optical region; and
an outer diameter surface disposed between the first side surface and the second side surface, wherein the outer diameter surface is farther to the central axis than each of the first side surface and the second side surface to the central axis, the outer diameter surface comprising:
an arc region being an arc-shaped centered on the central axis and having two arc ends, wherein the arc region comprises a first stripe structure portion, the first stripe structure portion has a plurality of first stripe structures, which extends from the first side surface to the second side surface, and the first stripe structures are arranged along the arc region around the central axis;
a shrinking region extending along a direction around the central axis and having two end portions, the two end portions of the shrinking region corresponded to the two arc ends of the arc region, and the shrinking region being closer to the central axis than the arc region to the central axis, wherein the shrinking region comprises a second stripe structure portion, the second stripe structure portion has a plurality of second stripe structures, which extends from the first side surface to the second side surface, and the second stripe structures are arranged from one of the two end portions to the other one of the two portions;
wherein, the outer diameter surface further comprises a transition region disposed between the two arc ends and the two end portions, and connecting the shrinking region and the arc region, wherein the transition region comprises a third stripe structure portion, the third stripe structure portion has at least two third stripe structures, which extends from the first side surface to the second side surface, an extending line of each of the at least two third stripe structures meets with each other on one point.

34. The image lens element of claim 33, wherein each of the first stripe structures and each of the second stripe structures have a wedge-shaped tapered structure, and the wedge-shaped tapered structure tapers towards the direction farther from the central axis.

35. The image lens element of claim 33, wherein each of the at least two third stripe structures has a wedge-shaped tapered structure, and the wedge-shaped tapered structure tapers towards the direction farther from the central axis.

36. The image lens element of claim 33, wherein a first angle is formed between the first stripe structure portion and the central axis, the first angle is θ1, and the following condition is satisfied:
$$0 degrees \leq θ1 \leq 45 degrees .$$

37. The image lens element of claim 36, wherein the first angle is formed between the first stripe structure portion and the central axis, the first angle is θ1, and the following condition is satisfied:
$$0 degrees \leq θ1 \leq 25 degrees .$$

38. The image lens element of claim 33, wherein a second angle is formed between the second stripe structure portion and the central axis, the second angle is θ2, and the following condition is satisfied:
$$0 degrees \leq θ2 \leq 45 degrees .$$

39. The image lens element of claim 38, wherein the second angle is formed between the second stripe structure portion and the central axis, the second angle is θ2, and the following condition is satisfied:
$$0 degrees \leq θ2 \leq 25 degrees .$$
